(19) United States
(12) Patent Application Publication
(10) Pub. No.: US 2026/0312887 A1
(43) Pub. Date: Oct. 8, 2026

(54) VIRTUAL RADIO POINTS SUPPORTING CLOUD RAN AND DAS

(71) Applicant: Outdoor Wireless Networks LLC, Richardson, TX (US)

(72) Inventors: Suresh N. Sriram, Bangalore (IN); Luigi Tarlazzi, Boxborough, MA (US); Christopher Goodman Ranson, Concord, VA (US); Stuart D. Sandberg, Acton, MA (US)

(73) Assignee: Outdoor Wireless Networks LLC, Richardson, TX (US)

(21) Appl. No.: 19/483,905

(22) PCT Filed: May 2, 2024
(86) PCT No.: PCT/US2024/027442

§ 371 Date: Nov. 12, 2025

(30) Foreign Application Priority Data
May 12, 2023 (DE) 202341033518

(51) Int. Cl. H04L 41/40; H04B 7/024

(52) U.S. Cl. CPC H04L 41/40; H04B 7/024

(57) ABSTRACT

Systems and methods for virtual radio points that support cloud RAN and DAS are provided herein. In certain embodiments, a system includes a baseband unit coupled to one or more base stations. Additionally, the system includes a master unit coupled to the one or more baseband units. Further, the system includes a plurality of radio units coupled to the master unit. Moreover, the master unit is configured to function as one or more virtual radio units.

### CROSS-REFERENCE TO RELATED APPLICATIONS

This application claims the benefit of Indian Provisional No. 202341033518, filed on May 12, 2023, which is hereby incorporated herein by reference in its entirety.

### BACKGROUND

A distributed antenna system (DAS) typically includes one or more central units or nodes (also referred to here as “central access nodes (CANs)” or “master units”) that are communicatively coupled to a plurality of remotely located access points or antenna units (also referred to here as “remote units” or “radio units”). Each access point can be coupled directly to one or more of the central access nodes. Also, each access point can be coupled indirectly via one or more other remote units or via one or more intermediary or expansion units or nodes (also referred to here as “transport expansion nodes (TENs)”). A DAS is typically used to improve the coverage provided by one or more base stations coupled to the central access nodes. These base stations can be coupled to the one or more central access nodes via one or more cables or via a wireless connection, for example, using one or more donor antennas. The wireless service provided by the base stations can include commercial cellular service or private or public safety wireless communications.

In general, each central access node receives one or more downlink signals from one or more base stations and generates one or more downlink transport signals derived from one or more of the received downlink base station signals. Each central access node transmits one or more downlink transport signals to one or more of the access points. Each access point receives the downlink transport signals transmitted to it from one or more central access nodes and uses the received downlink transport signals to generate one or more downlink radio frequency signals for radiation from one or more coverage antennas associated with that access point. The downlink radio frequency signals are radiated for reception by user equipment (UEs). Typically, the downlink radio frequency signals associated with each base station are simulcasted from multiple remote units. In this way, the DAS increases the coverage area for the downlink capacity provided by the base stations.

Likewise, each access point receives one or more uplink radio frequency signals transmitted from the user equipment. Each access point generates one or more uplink transport signals derived from the one or more uplink radio frequency signals and transmits the one or more uplink transport signals to one or more of the central access nodes. Each central access node receives the respective uplink transport signals transmitted to it from one or more access points and uses the received uplink transport signals to generate one or more uplink base station radio frequency signals that are provided to the one or more base stations associated with that central access node. Typically, receiving the uplink signals involves, among other things, summing uplink signals received from the multiple access points to produce the base station signal provided to each base station. In this way, the DAS increases the coverage area for the uplink capacity provided by the base stations.

A DAS can use either digital transport, analog transport, or combinations of digital and analog transport to generate and communicate the transport signals between the central access nodes, the access points, and any transport expansion nodes.

Traditionally, a DAS is operated in a “full simulcast” mode in which downlink signals for each base station are transmitted from multiple access points of the DAS and in which uplink signals for each base station are generated by summing uplink data received from the multiple access points.

The 3GPP fifth generation (5G) radio access network (RAN) architecture includes a set of base stations (also referred to as “gNBs”) connected to the 5G core network (5GC) and to each other. Each gNB typically comprises three entities—a centralized unit (CU), a distributed unit (DU), and a set of one or more radio units (RUs). The CU can be further split into one or more CU control plane entities (CU-CPs) and one or more CU user plane entities (CU-UPs). The functions of the RAN can be split among these entities in various ways. For example, the functional split between the DU and the RUs can be configured so that the DU implements some of the Layer-1 processing functions (for the wireless interface), and each RU implements the Layer-1 functions that are not implemented in the DU as well as the basic RF and antenna functions. The DU is coupled to each RU using a fronthaul network (for example, one implemented using a switched Ethernet network) over which data is communicated between the DU and each RU. The data includes, for example, user-plane data (for example, in-phase and quadrature (IQ) data representing time-domain or frequency-domain symbols). One example of such a configuration is a “cloud radio access network” or “cloud RAN” configuration in which each CU and DU are associated with multiple RUs.

### SUMMARY

Systems and methods for virtual radio points that support cloud RAN and DAS are provided herein. In certain embodiments, a system includes a baseband unit coupled to one or more base stations. Additionally, the system includes a master unit coupled to the one or more baseband units. Further, the system includes a plurality of radio units coupled to the master unit. Moreover, the master unit is configured to function as one or more virtual radio units.

### BRIEF DESCRIPTION OF THE DRAWINGS

Drawings accompany this description and depict only some embodiments associated with the scope of the appended claims. Thus, the described and depicted embodiments should not be considered limiting in scope. The accompanying drawings and specification describe the exemplary embodiments, and features thereof, with additional specificity and detail, in which:

FIGS. 1A-1C are block diagrams illustrating exemplary embodiments of a virtualized DAS according to an aspect of the present disclosure;

FIG. 2 is a block diagram illustrating an exemplary embodiment of an access point for use in a virtualized DAS according to an aspect of the present disclosure;

FIGS. 3A-3D are block diagrams illustrating exemplary embodiments of a virtualized DAS having access points coupled to virtual MUs according to an aspect of the present disclosure;

FIG. 4 is a block diagram illustrating an exemplary embodiment of a virtualized DAS where an RF interface bypasses a virtualized MU according to an aspect of the present disclosure;

FIG. 5 is a block diagram of an exemplary radio access network system;

FIG. 6 is a block diagram illustrating a hybrid functional split in the uplink direction according to an aspect of the present disclosure;

FIG. 7 is a block diagram illustrating a hybrid functional split in the downlink direction according to an aspect of the present disclosure;

FIG. 8 is a block diagram of a system incorporating a master unit as a virtual radio point according to an aspect of the present disclosure; and

FIG. 9 is a flowchart diagram of a method for implementing virtual radio units to support cloud RAN and DAS according to an aspect of the present disclosure.

Per common practice, the drawings do not show the various described features according to scale, but the drawings show the features to emphasize the relevance of the features to the example embodiments.

### DETAILED DESCRIPTION

The following detailed description refers to the accompanying drawings that form a part of the present specification. The drawings, through illustration, show specific illustrative embodiments. However, it is to be understood that other embodiments may be used and that logical, mechanical, and electrical changes may be made.

Systems and methods for virtual radio points supporting cloud RAN and DAS are provided. Some 4G and 5G systems natively support a set of RUs per Cell (i.e., 64 RUs) and per BBU (i.e., 128 RUs). A typical DAS system receives signals through an RF, CPRI, or ORAN Interface as donor sources and distributes the signals over multiple radio points (RUs). When receiving uplink signals, the DAS may sum the received uplink signals to form a single uplink stream per carrier.

Additionally, some systems that support 4G and 5G have a functional divide between baseband and the RUs. To support higher numbers of RUs, some channels are processed in some RUs to form a hybrid split. In at least one example, some communication channels are processed in an RU to decrease the load on a baseband unit (BBU). In particular, the RU may process the SRS, PRACH, and PUCCH channels. When a BBU handles the aforementioned channels for a large number of RUs, the BBU has to process each of the channels for each of the RUs, placing a substantial load on the BBU and limiting the front-haul bandwidth supported by the BBU. The same issue exists for the downlink direction as an RU processes the Precoder and Layer mapping in RU to reduce the IQ transport in the front-haul.

Further, some systems may be deployed along with a DAS. When deployed with a DAS, the combination of systems may present some challenges. For example, a system may require that some control channels be processed per RU to perform localization for user equipment. For example, a DAS may sum up all uplinks into a single stream, resulting in the loss of localization. When there is an absence of localization, it is not possible to reuse some of the deployed resources. Additionally, a system may use interference rejection combining across multiple RUs for a particular UE. As the interference rejection combining requires localization, the interference rejection combining is also not possible with the DAS combining case. When a DAS is connected via an RF source, the number of RUs used for reuse and radio point combining may increase the DAS input donor configuration, increasing the DAS cost.

Traditionally, when a BBU of a base station is coupled directly to a DAS using a digital donor card, the physical interface implemented by the digital donor card is typically configured to be coupled to a single BBU and to appear, from the perspective of that BBU, to be a single RRH, even if that BBU has features that can use multiple RRHs. In contrast to a traditional DAS, the DAS described here comprises a donor card (VRU donor card) supporting virtual RUs. The VRU donor card is configured to instantiate multiple virtual radio units (VRUs) for any baseband entity coupled to that donor card. For a given baseband entity, each VRU instantiated for it is associated with a respective set of RUs of the DAS. This set of DAS RUs is also referred to here as the “simulcast zone” for that virtual RU. In one implementation of this embodiment, the respective simulcast zones associated with the various VRUs instantiated for a given baseband entity are unique in that they all differ from each other. A simulcast zone differs from another simulcast zone when the respective sets of DAS RUs are not the same.

For a given baseband entity, each VRU instantiated for it is configured to appear to that baseband entity as a separate radio unit (RU), radio point (RP), or remote radio head (RRH) of the type that the baseband entity is configured to work with. As a part of doing this, the VRU donor card is configured to implement the control-plane, user-plane, synchronization-plane, and management-plane functions that such a RU, RP, or RRU would implement. Each VRU appears to the associated baseband entity to be a separate, single RU, RP, or RRH, even though multiple DAS RUs are being used to wirelessly transmit and receive RF signals for the associated base station.

In certain embodiments, BBU data can be routed to a Master Unit (MU), which acts as one or more virtual radio units. The virtual radio units may be connected to physical DAS RUs in one or more topologies. For example, the topologies may be 1:1, 1:N, or N:1. The number of virtual RU's may depend on the number of reuse layers and independent processing of PUCCH, PUSCH Reception RU's Per UE in the Combining Zone, SRS, and PRACH Channels.

The MU hosting the virtual RU's may be scaled horizontally or vertically based on a deployment configuration. The MU can run on COTS hardware, and cores/memory requirements may depend on the number of vRUs. The MU can operate in an ORAN Donor to MU to ORAN Interface, a CPRI Donor to MU to ORAN/CPRI Carrier, and the like. The MU has interface translation, acting as an MU on the southbound interface and from the northbound interface acting as a BBU interface.

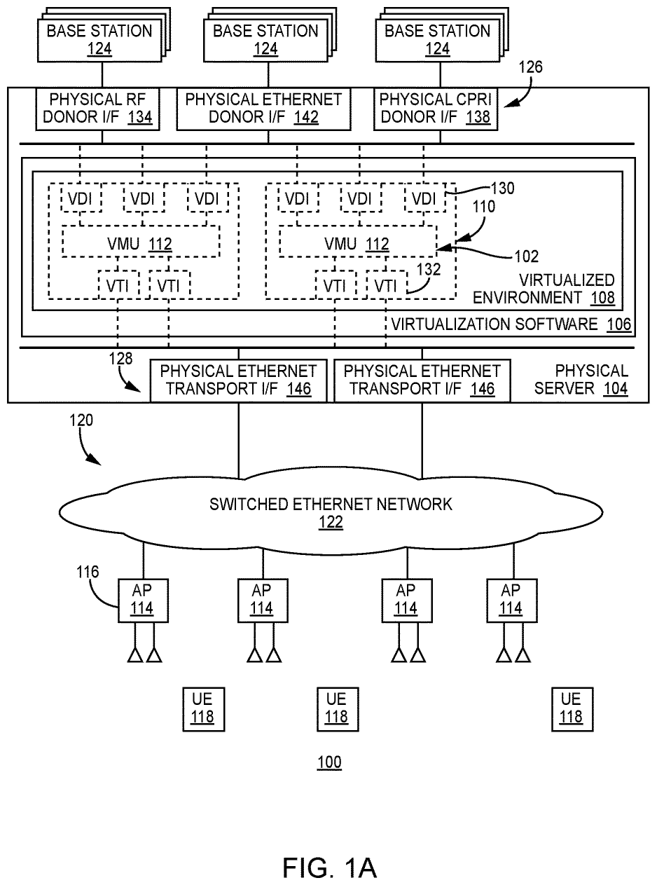

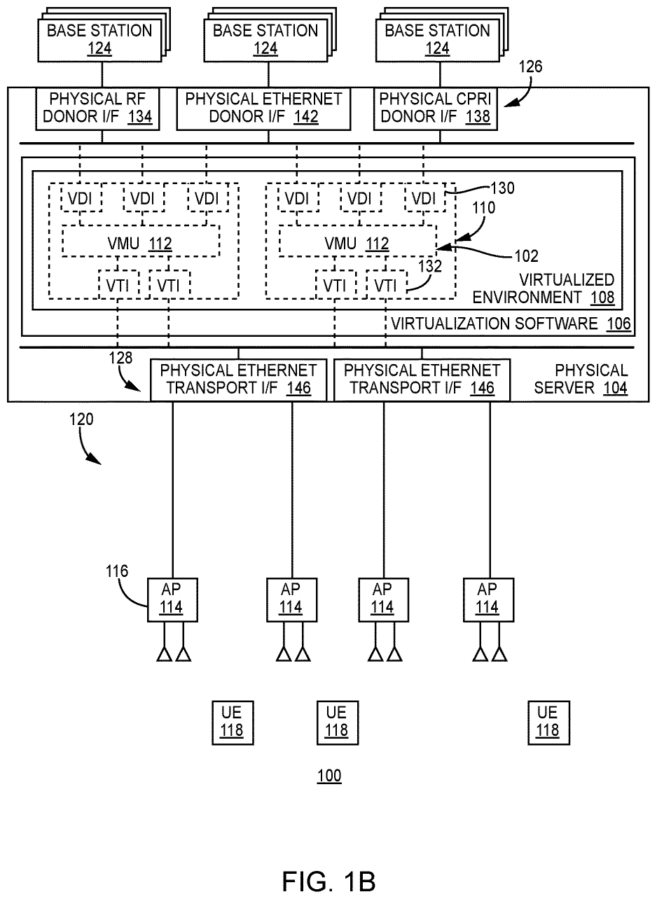

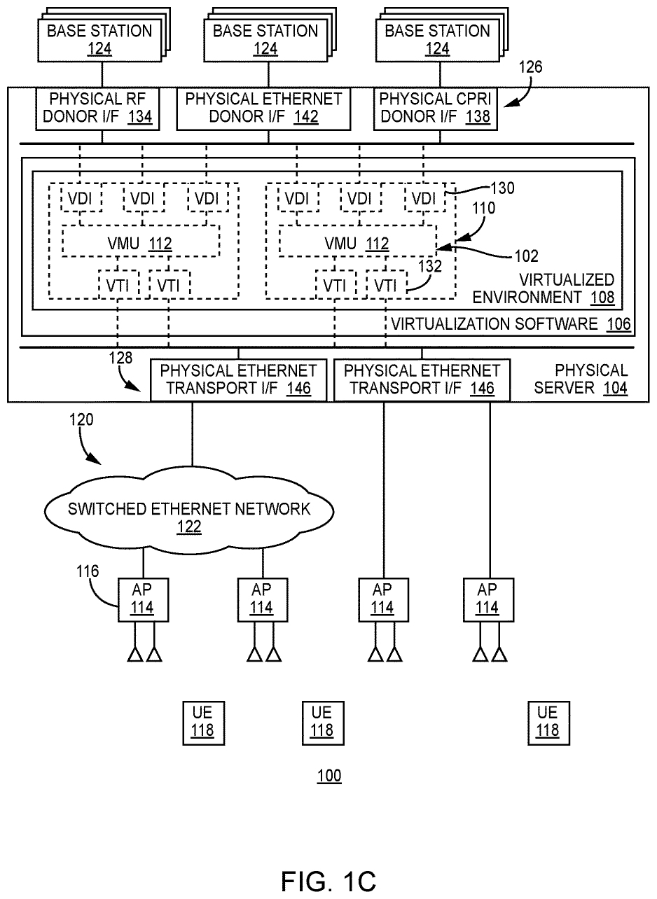

FIGS. 1A-1C are block diagrams illustrating one exemplary embodiment of a virtualized DAS (vDAS) 100 that can receive signals from multiple sources, including receiving signals from a baseband unit, as discussed above. While a vDAS is shown, some of the features described below may also apply to a non-virtualized DAS. In the exemplary embodiment of the virtualized DAS 100 shown in FIGS. 1A-1C, one or more nodes or functions of a traditional DAS (such as a master unit or CAN) are implemented using one or more virtual network functions (VNFs) 102 executing on one or more physical server computers (also referred to here as “physical servers” or just “servers”) 104 (for example, one or more commercial-off-the-shelf (COTS) servers of the type that are deployed in data centers or “clouds” maintained by enterprises, communication service providers, or cloud services providers).

Each such physical server computer 104 is configured to execute software configured to implement the various functions and features described here as being implemented by the associated VNF 102. Each such physical server computer 104 comprises one or more programmable processors for executing such software. The software comprises program instructions that are stored (or otherwise embodied) on or in an appropriate non-transitory storage medium or media (such as flash or other non-volatile memory, magnetic disc drives, and/or optical disc drives) from which at least a portion of the program instructions are read by the respective programmable processor for execution thereby. Both local storage media and remote storage media (for example, storage media that is accessible over a network), as well as removable media, can be used. Each such physical server computer 104 also includes memory for storing the program instructions (and any related data) during execution by the respective programmable processor.

In the example shown in FIGS. 1A-1C, virtualization software 106 is executed on each physical server computer 104 to provide a virtualized environment 108 in which one or more virtual entities 110 (such as one or more virtual machines and/or containers) are used to deploy and execute the one or more VNFs 102 of the vDAS 100. In the following description, it should be understood that references to “virtualization” are intended to refer to, and include within their scope, any type of virtualization technology, including “container” based virtualization technology (such as, but not limited to, Kubernetes).

In the example shown in FIGS. 1A-1C, the vDAS 100 comprises at least one virtualized master unit (vMU) 112 and a plurality of access points (APs) (also referred to herein as “remote antenna units” (RAUs) or “radio units” (RUs)) 114. Each vMU 112 is configured to implement the functions normally carried out by a physical master unit or CAN in a traditional DAS.

Each of the vMUs 112 is implemented as a respective VNF 102 deployed on one or more physical servers 104. Each of the APs 114 is implemented as a physical network function (PNF) and is deployed in or near a physical location where coverage is to be provided by an associated AP 114.

Each of the APs 114 includes, or is otherwise coupled to, one or more coverage antennas 116 via which downlink radio frequency (RF) signals are radiated for reception by user equipment (UEs) 118 and via which uplink RF signals transmitted from UEs 118 are received. Each of the APs 114 is communicatively coupled to the respective one or more vMUs 112 (and the physical server computers 104 on which the vMUs 112 are deployed) using a fronthaul network 120. The fronthaul network 120 used for transport between each vMU 112 and the APs 114 can be implemented in various ways. Various examples of how the fronthaul network 120 can be implemented are illustrated in FIGS. 1A-1C. In the example shown in FIG. 1A, the fronthaul network 120 is implemented using a switched Ethernet network 122 that is used to communicatively couple each AP 114 to each vMU 112 serving that AP 114. That is, in contrast to a traditional DAS in which each AP is coupled to each CAN serving it using only point-to-point links, in the vDAS 100 shown in FIG. 1A, each AP 114 is coupled to each vMU 112 serving it, using at least some of the shared communication links.

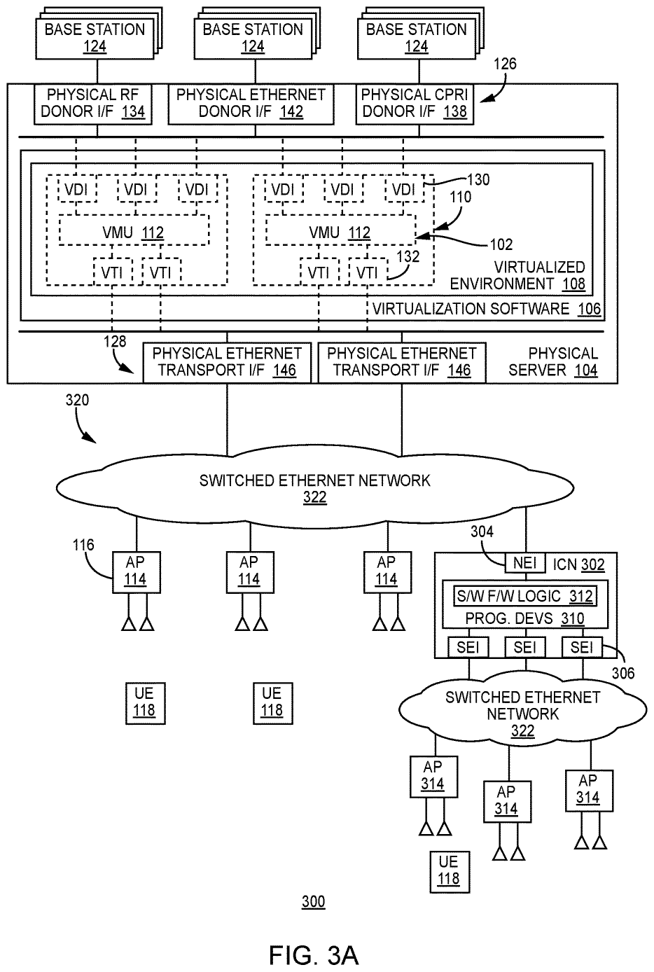

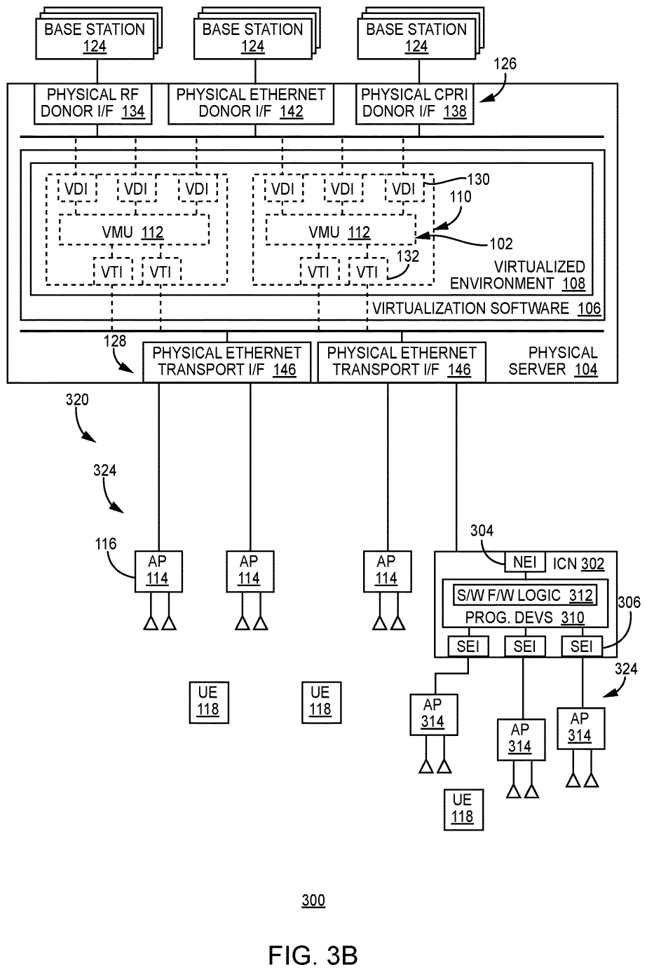

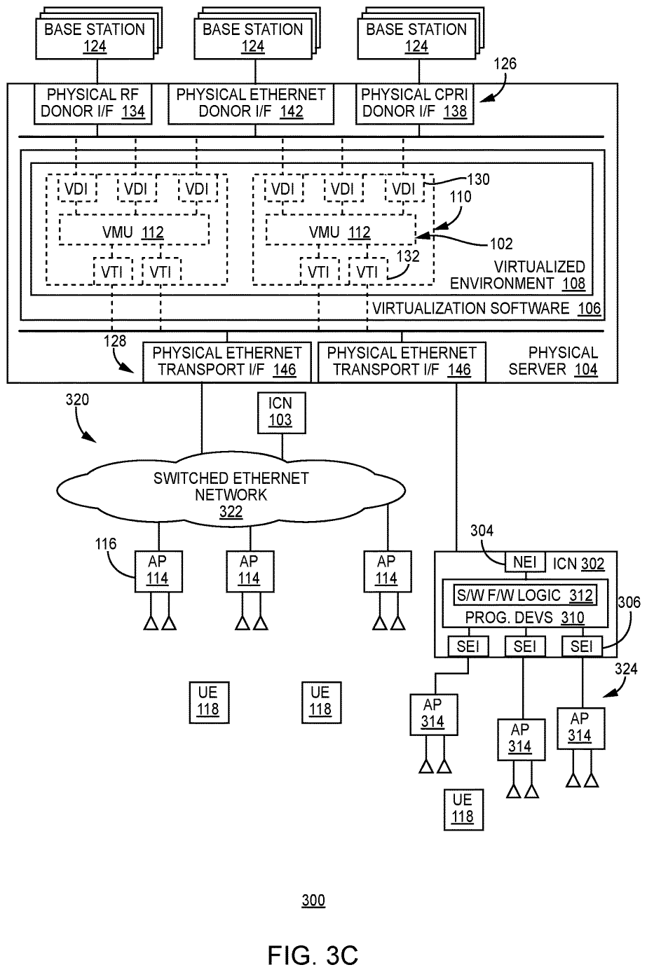

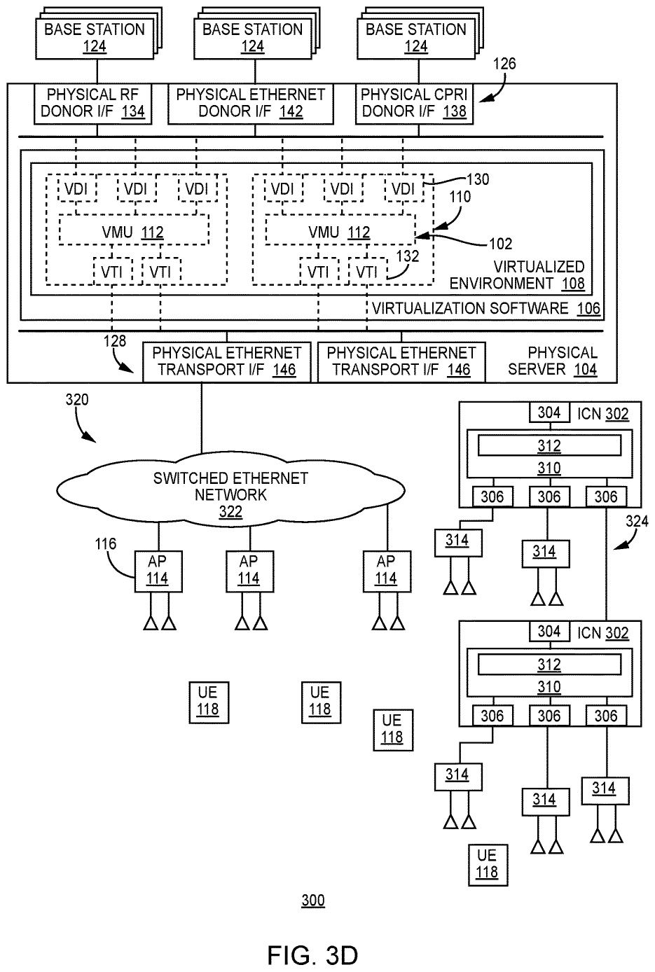

In the example shown in FIG. 1B, the fronthaul network 120 is implemented using only point-to-point Ethernet links, where each AP 114 is coupled to each serving vMU 112 serving it via a respective one or more point-to-point Ethernet links. In the example shown in FIG. 1C, the fronthaul network 120 is implemented using a combination of a switched Ethernet network 122 and point-to-point Ethernet links, where at least one AP 114 is coupled to a vMU 112 serving it at least in part using the switched Ethernet network 122 and at least one AP 114 where at least one AP 114 is coupled to a vMU 112 serving it at least in part using at least one point-to-point Ethernet link 124. FIGS. 3A-3D are block diagrams illustrating other examples in which one or more intermediate combining nodes (ICNs) 302 are used. The examples shown in FIGS. 3A-3D are described below. It is to be understood, however, that FIGS. 1A-1C and 3A-3D illustrate only a few examples of how the fronthaul network (and the vDAS more generally) can be implemented and that other variations are possible.

The vDAS 100 is configured to be coupled to one or more base stations 124, to improve the coverage provided by the base stations 124. That is, each base station 124 is configured to provide wireless capacity, whereas the vDAS 100 is configured to provide improved wireless coverage for the wireless capacity provided by the base station 124. As used here, unless otherwise explicitly indicated, references to “base station” include both (1) a “complete” base station that interfaces with the vDAS 100 using the analog radio frequency (RF) interface that would otherwise be used to couple the complete base station to a set of antennas as well as (2) a first portion of a base station 124 (such as a baseband unit (BBU), distributed unit (DU), or similar base station entity) that interfaces with the vDAS 100 using a digital fronthaul interface that would otherwise be used to couple that first portion of the base station to a second portion of the base station (such as a remote radio head (RRH), radio unit (RU), or similar radio entity). In the latter case, different digital fronthaul interfaces can be used (including, for example, a Common Public Radio Interface (CPRI) interface, an evolved CPRI (eCPRI) interface, an IEEE 1914.3 Radio-over-Ethernet (RoE) interface, a functional application programming interface (FAPI) interface, a network FAPI (nFAPI) interface), or an Open-RAN (O-RAN) fronthaul interface) and different functional splits can be supported (including, for example, functional split 4, functional split 7-2, and functional split 6).

Each base station 124 coupled to the vDAS 100 can be co-located with the vMU 112 to which it is coupled. A co-located base station 124 can be coupled to the vMU 112 to which it is coupled using one or more point-to-point links (for example, where the co-located base station 124 comprises a 4G LTE BBU supporting a CPRI fronthaul interface, the 4G LTE BBU can be coupled to the vMU 112 using one or more optical fibers that directly connect the BBU to the vMU 112) or a shared network (for example, where the co-located base station 124 comprises a DU supporting an Ethernet-based fronthaul interface (such as an O-RAN or eCPRI fronthaul interface), the co-located DU can be coupled to the vMU 112 using a switched Ethernet network). Each base station 124 coupled to the vDAS 100 can also be located remotely from the vMU 112 to which it is coupled. A remote base station 124 can be coupled to the vMU 112 to which it is coupled via a wireless connection (for example, by using a donor antenna to wirelessly couple the remote base station 124 to the vMU 112 using an analog RF interface) or via a wired connection (for example, where the remote base station 124 comprises a DU supporting an Ethernet-based fronthaul interface (such as an O-RAN or eCPRI fronthaul interface), the remote DU can be coupled to the vMU 112 using an Internet Protocol (IP)-based network such as the Internet).

The vDAS 100 described here is especially well-suited for use in deployments in which base stations 124 from multiple wireless service operators share the same vDAS 100 (including, for example, neutral host deployments or deployments where one wireless service operator owns the vDAS 100 and provides other wireless service operators with access to its vDAS 100). For example, multiple vMUs 112 can be instantiated, where a different group of one or more vMUs 112 can be used with each of the wireless service operators (and the base stations 124 of that wireless service operator). The vDAS 100 described here is especially well-suited for such deployments because vMUs 112 can be easily instantiated to support additional wireless service operators. The vMUs can be easily instantiated even if an additional physical server computer 104 is needed to instantiate a new vMU 112 because such physical server computers 104 are either already available in such deployments or can be easily added at a low cost (for example, because of the COTS nature of such hardware).

The physical server computer 104 on which each vMU 112 is deployed includes one or more physical donor interfaces 126 that are each configured to communicatively couple the vMU 112 (and the physical server computer 104 on which it is deployed) to one or more base stations 124. Also, the physical server computer 104 on which each vMU 112 is deployed includes one or more physical transport interfaces 128 that are each configured to communicatively couple the vMU 112 (and the physical server computer 104 on which it is deployed) to the fronthaul network 120 (and ultimately the APs 114). Each physical donor interface 126 and physical transport interface 128 is a physical network function (PNF) (for example, implemented as a Peripheral Computer Interconnect Express (PCIe) device) deployed in or with the physical server computer 104.

In the example shown in FIGS. 1A-1C, each physical server computer 104 on which each vMU 112 is deployed includes separate physical donor and transport interfaces 126 and 128. However, it is to be understood that, in other embodiments, a single set of physical interfaces 126 and 128 can be used for both donor purposes (that is, communication between the vMU 112 to one or more base stations 124) and for transport purposes (that is, communication between the vMU 112 and the APs 114 over the fronthaul network 120).

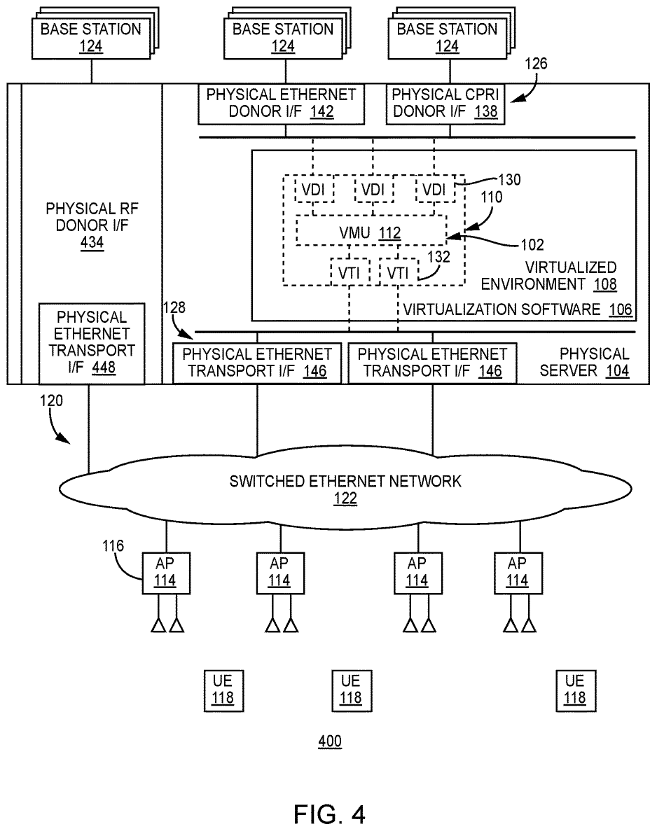

In the exemplary embodiment shown in FIGS. 1A-1C, the physical donor interfaces 126 comprise one or more physical RF donor interfaces (also referred to here as “physical RF donor cards”) 134. Each physical RF donor interface 134 is in communication with one or more vMUs 112 executing on the physical server computer 104 in which that physical RF donor interface 134 is deployed (for example, by communicating over a PCIe lane with a central processing unit (CPU) used to execute each such vMU 112). Each physical RF donor interface 134 includes one or more sets of physical RF ports (not shown) to couple the physical RF donor interface 134 to one or more base stations 124 using an analog RF interface. Each physical RF donor interface 134 is configured, for each base station 124 coupled to it, to receive downlink analog RF signals from the base station 124 via respective RF ports, convert the received downlink analog RF signals to digital downlink time-domain data, and output it to a vMU 112 executing on the same server computer 104 in which that RF donor interface 134 is deployed. Also, each physical RF donor interface 134 is configured, for each base station 124 coupled to it, to receive summed digital uplink time-domain data from the vMU 112, convert the received summed digital uplink time-domain data to uplink analog RF signals, and output the uplink analog RF signals to the base station 124. Moreover, the digital downlink time-domain data produced and the digital uplink time-domain data received by each physical RF donor interface 134 can be in the form of real digital values or complex (that is, in-phase and quadrature (IQ)) digital values and at baseband (that is, centered around 0 Hertz) or with a frequency offset near baseband or an intermediate frequency (IF). Alternatively, as described in more detail below in connection with FIG. 4, one or more of the physical RF donor interfaces can be configured to bypass the vMU 112 and instead, for the base stations 124 coupled to that physical RF donor interface, have that physical RF donor interface perform the functions described here as being performed by the vMU 112 (including the digital combining or summing of user-plane data).

In the exemplary embodiment shown in FIGS. 1A-1C, the physical donor interfaces 126 also include one or more physical CPRI donor interfaces (also referred to here as “physical CPRI donor cards”) 138. Each physical CPRI donor interface 138 is in communication with one or more vMUs 112 executing on the physical server computer 104 in which that physical CPRI donor interface 138 is deployed (for example, by communicating over a PCIe lane with a CPU used to execute each such vMU 112). Each physical CPRI donor interface 138 includes one or more sets of physical CPRI ports (not shown) to couple the physical CPRI donor interface 138 to one or more base stations 124 using a CPRI interface. More specifically, in this example, each base station 124 coupled to the physical CPRI donor interface 138 comprises a BBU or DU configured to communicate with a corresponding RRH or RU using a CPRI fronthaul interface. Each physical CPRI donor interface 138 is configured, for each base station 124 coupled to it, to receive from the base station 124 via a CPRI port digital downlink data formatted for the CPRI fronthaul interface, extract the digital downlink data, and output it to a vMU 112 executing on the same server computer 104 in which that CPRI donor interface 138 is deployed. Also, each physical CPRI donor interface 138 is configured, for each base station 124 coupled to it, to receive summed digital uplink digital data from the vMU 112, format it for the CPRI fronthaul interface, and output the CPRI formatted data to the base station 124 via a CPRI port.

In the exemplary embodiment shown in FIGS. 1A-1C, the physical donor interfaces 126 also include one or more physical donor Ethernet interfaces 142. Each physical donor Ethernet interface 142 is in communication with one or more vMUs 112 executing on the physical server computer 104 in which that physical donor Ethernet interface 142 is deployed (for example, by communicating over a PCIe lane with a CPU used to execute each such vMU 112). Each physical donor Ethernet interface 142 includes one or more sets of physical donor Ethernet ports (not shown) to couple the physical donor Ethernet interface 142 to one or more base stations 124 so that each vMU 112 can communicate with the one or more base stations 124 using an Ethernet-based digital fronthaul interface (for example, an O-RAN or eCPRI fronthaul interface). More specifically, in this example, each base station 124 coupled to the physical donor Ethernet interface 142 comprises a BBU or DU configured to communicate with a corresponding RRH or RU using an Ethernet-based fronthaul interface. Each donor Ethernet interface 142 is configured, for each base station 124 coupled to it, to receive from the base station 124 digital downlink fronthaul data formatted as Ethernet data, extract the digital downlink fronthaul data, and output it to a vMU 112 executing on the same server computer 104 in which that donor Ethernet interface 142 is deployed. Also, each physical donor Ethernet interface 142 is configured, for each base station 124 coupled to it, to receive summed digital fronthaul data from the vMU 112 and output it to the base station 124 via an Ethernet port.

In the exemplary embodiment shown in FIGS. 1A-1C, the physical transport interfaces 128 comprise one or more physical Ethernet transport interfaces 146. Each physical transport Ethernet interface 146 is in communication with one or more vMUs 112 executing on the physical server computer 104 in which that physical transport Ethernet interface 146 is deployed (for example, by communicating over a PCIe lane with a CPU used to execute each such vMU 112). Each physical transport Ethernet interface 146 includes one or more sets of Ethernet ports (not shown) to couple the physical transport Ethernet interface 146 to the Ethernet cabling used to implement the fronthaul network 120 so that each vMU 112 can communicate with the various APs 114.

In this exemplary embodiment, the virtualization software 106 is configured to implement within the virtual environment 108 a respective virtual interface for each of the physical donor interfaces 126 and physical transport Ethernet interfaces 146 to provide and control access to the associated physical interface by each vMU 112 implemented within that virtual environment 108. That is, the virtualization software 106 is configured so that the virtual entity 110 used to implement each vMU 112 includes a virtual donor interface (VDI) 130 that virtualizes and controls access to the underlying physical donor interface 126. Likewise, the virtualization software 106 is configured so that the virtual entity 110 used to implement each vMU 112 includes a virtual transport interface (VTI) 132 that virtualizes and controls access to the underlying physical transport interface 128. For each port of each physical Ethernet transport interface 146, the physical Ethernet transport interface 146 (and each corresponding virtual transport interface 132) is configured to communicate over a switched Ethernet network or over a point-to-point Ethernet link depending on how the fronthaul network 120 is implemented (more specifically, depending whether the particular Ethernet cabling connected to that port is being used to implement a part of a switched Ethernet network or is being used to implement a point-to-point Ethernet link).

In general, each vMU 112 is configured to receive one or more downlink base station signals from one or more base stations 124 using one or more of the physical donor interfaces 126 and generate downlink transport data derived from the received downlink base station signals. Each vMU 112 is also configured to, for each such base station 124, communicate downlink transport data for that base station 124 to a set of APs 114 used to serve that base station 124. The set of APs 114 used to serve a base station 124 is also referred to here as the “simulcast zone” for that base station 124. Each AP 114 in the simulcast zone of a base station 124 receives downlink transport data for that base station 124 transmitted to it from the serving vMU 112 and uses the received downlink transport data to generate one or more downlink RF signals for that base station 124 that are radiated from the coverage antennas 116 associated with that AP 114. The downlink RF signals are radiated for reception by UEs 118. Typically, the simulcast zone for each base station 124 includes multiple APs 114. In this way, the vDAS 100 increases the coverage area for the downlink capacity provided by the base stations 124. Different base stations 124 (including different base stations 124 from different wireless service operators in deployments where multiple wireless service operators share the same vDAS 100) can have different simulcast zones defined for them.

Likewise, each AP 114 in the simulcast zone of a base station 124 receives one or more uplink RF signals transmitted from UEs 118 being served by the base station 124. Each such AP 114 generates uplink transport data derived from the one or more uplink RF signals and transmits it to the vMU 112 serving that base station 124. The serving vMU 112 receives the respective uplink transport data transmitted from the APs 114 in the base station's simulcast zone. For each base station 124, one or more uplink base station signals are generated by the vMU 112 and associated physical donor interface 126. The uplink base station signals are provided to the base station 124. Typically, the process of generating the uplink base station signals for a base station 124 involves, among other things, combining or summing uplink data received from the APs 114 in the base station's simulcast zone. In this way, the vDAS 100 increases the coverage area for the uplink capacity provided by the base stations 124.

Also, for any base station 124 coupled to the vDAS 100 using a CPRI fronthaul interface or an Ethernet fronthaul interface, the associated vMU 112 is configured to appear to that base station 124 (that is, the associated BBU or DU) as a single RU or RRH of the type that the base station 124 is configured to work with (for example, as a CPRI RU or RRH where the associated BBU or DU is coupled to the vDAS 100 using a CPRI fronthaul interface or as an O-RAN, eCPRI, or RoE RU or RRH where the associated BBU or DU is coupled to the vDAS 100 using an O-RAN, eCPRI, or RoE fronthaul interface). As a part of doing this, the vMU 112 is configured to implement the control-plane, user-plane, synchronization-plane, and management-plane functions that such a RU or RRU would implement. Stated another way, in this example, the vMU 112 is configured to implement a single “virtual” RU or RRH for the associated base station 124 even though multiple APs 114 are actually being used to wirelessly transmit and receive RF signals for that base station 124.

In some implementations, the content of the transport data communicated between each AP 114 and a serving vMU 112 depends on the functional split used by the associated base station 124. That is, where the associated base station 124 comprises a DU or BBU that is configured to use a functional split 7-2, the transport data comprises frequency-domain user plane data. Where the associated base station 124 comprises a DU or BBU that is configured to use functional split 4 or a where the associated base station 124 comprises a “complete” base station that is coupled to a vMU 112 using an analog RF interface, the transport data comprises time-domain user plane data.

In other implementations, the content of the transport data communicated between each AP 114 and each serving vMU 112 is the same regardless of the functional split used by the associated base station 124. For example, in one such implementation, the transport data communicated between each AP 114 and a serving vMU 112 comprises frequency-domain user plane data, regardless of the functional split used by the associated base station 124. In such implementations, the vMU 112 converts the user plane data as needed (for example, by converting the time-domain user plane data to frequency-domain user plane data and generating associated control plane data).

In general, the physical layer baseband processing required to be performed by an RU entity for a given served base station 124 depends on the functional split used for the transport data.

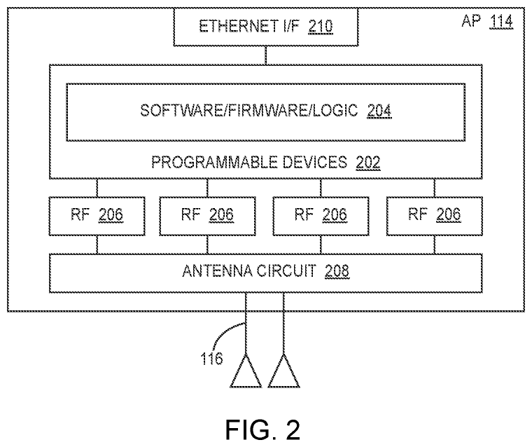

In the exemplary embodiment shown in FIG. 2, the AP 114 comprises multiple radio frequency (RF) modules 206. Each RF module 206 comprises circuitry that implements the RF transceiver functions for a given RU entity implemented using that physical AP 114 and provides an interface to the coverage antennas 116 associated with that AP 114. Each RF module 206 can be implemented using one or more RF integrated circuits (RFICs) and/or discrete components.

Each RF module 206 comprises circuitry that implements, for the associated RU entity, a respective downlink and uplink signal path for each of the coverage antennas 116 associated with that physical AP 114. In one exemplary implementation, each downlink signal path receives the downlink baseband IQ data output by the one or more programmable devices 202 for the associated coverage antenna 116, converts the downlink baseband IQ data to an analog signal (including the various physical channels and associated sub carriers), upconverts the analog signal to the appropriate RF band (if necessary), and filters and power amplifies the analog RF signal. (The up-conversion to the appropriate RF band can be done directly by the digital-to-analog conversion process outputting the analog signal in the appropriate RF band or via an analog upconverter included in that downlink signal path.) The resulting amplified downlink analog RF signal output by each downlink signal path is provided to the associated coverage antenna 116 via an antenna circuit 208 (which implements any needed frequency-division duplexing (FDD) or time-division-duplexing (TDD) functions), including filtering and combining.

In one exemplary implementation, the uplink RF analog signal (including the various physical channels and associated sub-carriers) received by each coverage antenna 116 is provided, via the antenna circuit 208, to an associated uplink signal path in each RF module 206.

Each uplink signal path in each RF module 206 receives the uplink RF analog received via the associated coverage antenna 116, low-noise amplifies the uplink RF analog signal, and, if necessary, filters and, if necessary, down-converts the resulting signal to produce an intermediate frequency (IF) or zero IF version of the signal.

Each uplink signal path in each RF module 206 converts the resulting analog signals to real or IQ digital samples and outputs them to the one or more programmable logical devices 202 for uplink signal processing. (The analog-to-digital conversion process can be implemented using a direct RF ADC that can receive and digitize RF signals, in which case no analog down-conversion is necessary.)

Also, in this exemplary embodiment, for each coverage antenna 116, the antenna circuit 208 is configured to combine (for example, using one or more band combiners) the amplified analog RF signals output by the appropriate downlink signal paths of the various RF modules 206 for transmission using each coverage antenna 116 and to output the resulting combined signal to that coverage antenna 116. Likewise, in this exemplary embodiment, for each coverage antenna 116, the antenna circuit 208 is configured to split (for example, using one or more band filters and/or RF splitters) the uplink analog RF signals received using that coverage antenna 116 in order to supply, to the appropriate uplink signal paths of the RF modules 206 used for that antenna 116, a respective uplink analog RF signals for that signal path.

It is to be understood that the preceding description is one example of how each downlink and uplink signal path of each RF module 206 can be implemented; it is to be understood, however, that the downlink and uplink signal paths can be implemented in other ways.

The AP 114 further comprises at least one Ethernet interface 210 that is configured to communicatively couple the AP 114 to the fronthaul network 120 and, ultimately, to the vMU 112. For each port of each Ethernet interface 210, the Ethernet 210 is configured to communicate over a switched Ethernet network or over a point-to-point Ether link depending on how the fronthaul network 120 is implemented (more specifically, depending on whether the particular Ethernet cabling connected to that port is being used to implement a part of a switched Ethernet network or is being used to implement a point-to-point Ethernet link).

In one example of the operation of the vDAS 100 of FIGS. 1A-1C and 2, each base station 124 coupled to the vDAS 100 is served by a respective set of APs 114. As noted above, the set of APs 114 serving each base station 124 is also referred to here as the “simulcast zone” for that base station 124 and different base stations 124 (including different base stations 124 from different wireless service operators in deployments where multiple wireless service operators share the same vDAS 100) can have different simulcast zones defined for them.

In the downlink direction, one or more downlink base station signals from each base station 124 are received by a physical donor interface 126 of the vDAS 100, which generates downlink base station data using the received downlink base station signals and provides the downlink base station data to the vMU 112.

The form that the downlink base station signals take and how the downlink base station data is generated from the downlink base station signals depends on how the base station 124 is coupled to the vDAS 100.

For example, where the base station 124 is coupled to the vDAS 100 using an analog RF interface, the base station 124 is configured to output from its antenna ports a set of downlink analog RF signals. Thus, in this example, the one or more downlink base station signals comprise the set of downlink analog RF signals output by the base station 124 that would otherwise be radiated from a set of antennas coupled to the antenna ports. In this example, the physical donor interface 126 used to receive the downlink base station signals comprises a physical RF donor interface 134. Each of the downlink analog RF signals is received by a respective RF port of the physical RF donor interface 134 installed in the physical server computer 104 executing the vMU 112. The physical RF donor interface 134 is configured to receive each downlink analog RF signal (including the various physical channels and associated sub-carriers) output by the base station 124 and generate the downlink base station data by generating corresponding time-domain baseband in-phase and quadrature (IQ) data from the received download analog RF signals (for example, by performing an analog-to-digital (ADC) and digital down-conversion process on the received downlink analog RF signal). The generated downlink base station data is provided to the vMU 112 (for example, by communicating it over a PCIe lane to a CPU used to execute each vMU 112).

In another example, the base station 124 comprises a BBU or DU that is coupled to the vDAS 100 using a CPRI fronthaul interface. In this example, the one or more downlink base station signals comprise the downlink CPRI fronthaul signal output by the base station 124 that would otherwise be communicated over a CPRI link to a RU. In this example, the physical donor interface 126 used to receive the one or more downlink base station signals comprises a physical CPRI donor interface 138. The downlink CPRI fronthaul signal is received by a CPRI port of the physical CPRI donor interface 138 installed in the physical server computer 104 executing the vMU 112. The physical CPRI donor interface 138 is configured to receive the downlink CPRI fronthaul signal, generate the downlink base station data by extracting downlink CPRI messages, and provide the generated downlink base station data to the vMU 112 (for example, by communicating it over a PCIe lane to a CPU used to execute the vMU 112). That is, in this example, the downlink base station data comprises the downlink CPRI messages extracted from the downlink CPRI fronthaul signal.

In another example, the base station 124 comprises a BBU or DU that is coupled to the vDAS 100 using an Ethernet fronthaul interface (for example, an O-RAN, eCPRI, or RoE fronthaul interface). In this example, the one or more downlink base station signals comprise the downlink Ethernet fronthaul signals output by the base station 124 (that is, the BBU or DU) that would otherwise be communicated over an Ethernet network to a RU. In this example, the physical donor interface 126 used to receive the one or more downlink base station signals comprises a physical Ethernet donor interface 142. The physical Ethernet donor interface 142 is configured to receive the downlink Ethernet fronthaul signals, generate the downlink base station data by extracting the downlink messages communicated using the Ethernet fronthaul interface, and provide the messages to the vMU 112 (for example, by communicating it over a PCIe lane to a CPU used to execute each the vMU 112). That is, in this example, the downlink base station data comprises the downlink messages extracted from the downlink Ethernet fronthaul signals.

The vMU 112 generates downlink transport data using the received downlink base station data and communicates, using a physical transport Ethernet interface 146, the downlink transport data from the vMU 112 to the set of APs 114 serving the base station 124.

The generated downlink transport data is communicated over the fronthaul network 120 to the APs 114 included in the simulcast zone of that base station 124. In one example, a multicast group is established for each different simulcast zone assigned to any base station 124 coupled to the vDAS 100. In such an example, the vMU 112 communicates the downlink transport data to the set of APs 114 serving the base station 124 by using one or more of the physical transport Ethernet interfaces 146 to transmit the downlink transport data as transport Ethernet packets addressed to the multicast group established for the simulcast zone associated with that base station 124. In this example, the vMU 112 is configured so that a part of the process of generating the downlink transport data includes formatting the transport Ethernet packets to use the address of the multicast group established for that simulcast zone. In another example, a separate virtual local area network (VLAN) is established for each different simulcast zone assigned to any base station 124 coupled to the vDAS 100, where only the APs 114 included in the associated simulcast zone and the associated vMUs 112 communicate data using that VLAN. In such an example, each vMU 112 is configured so that a part of the process of generating the downlink transport data includes formatting the transport Ethernet packets to be communicated with the VLAN established for that simulcast zone.

In another example, the vMU 112 broadcasts the downlink transport data to all of APs 114 of the vDAS 100 and each AP 114 is configured to determine if any downlink transport data it receives is intended for it. In this example, this can be done by including in the downlink transport data broadcast to the APs 114 a bitmap field that includes a respective bit position for each AP 114 included in the vDAS 100. Each bit position is set to one value (for example, a “1”) if the associated downlink transport data is intended for that AP 114 and is set to a different value (for example, a “0”) if the associated downlink transport data is not intended for that AP 114. In one such example, the bitmap is included in a header portion of the underlying message so that the AP 114 does not need to decode the entire message in order to determine if the associated message is intended for it or not. In one implementation, this can be done using an O-RAN section extension that is defined to include such a bitmap field in the common header fields. In this example, the vMU 112 is configured so that a part of the process of generating the downlink transport data includes formatting the downlink transport data to include a bitmap field, where the bit position for each AP 114 included in the base station's simulcast zone is set to the value (for example, a “1”) indicating that the data is intended for it and where the bit position for each AP 114 not included in the base station's simulcast zone is set to the other value (for example, a “0”) indicating that the data is not intended for it.

As a part of generating the downlink transport data, the vMU 112 performs any needed re-formatting or conversion of the received downlink base station data in order for it to comply with the format expected by the APs 114. For example, in the exemplary embodiment described here in connection with FIGS. 1A-1C and 2, the vDAS 100 is configured to use an O-RAN fronthaul interface for communications between the vMU 112 and the APs 114 and, as a result, the APs 114 are configured for use with, and to expect, fronthaul data formatted in accordance with the O-RAN fronthaul interface. In such an example, if the downlink base station data provided from the physical donor interface 126 to the vMU 112 is not already formatted in accordance with the O-RAN fronthaul interface, the vMU 112 re-formats and converts the downlink base station data so that the downlink transport data communicated to the APs 114 in the simulcast zone of the base station 124 is formatted in accordance with the O-RAN fronthaul interface used by the APs 114.

As noted above, in some implementations, both the content of the downlink transport data and the manner in which each vMU 112 generates the downlink transport data from the received downlink base station data depend on the functional split that is used by the associated base station 124 and, in other implementations, the content of the downlink transport data and the manner in which each vMU 112 generates the downlink transport data from the received downlink base station data is the same for all served base stations 124, regardless of the functional split used by the served base stations 124.

In those implementations where both the content of the downlink transport data and the manner in which each vMU 112 generates the downlink transport data from the received downlink base station data depend on the functional split that is used by the associated base station 124, if the base station 124 comprises a DU or BBU that is configured to use a functional split 7-2, the downlink transport data that is communicated between the vMU 112 and the APs 114 in the base station's simulcast zone comprises frequency-domain user-plane data and associated control-plane data for each antenna port of the base station 124. In such implementations, if a base station 124 comprises a DU or BBU that is configured to use functional split 4 or a where base station 124 comprises a “complete” base station that is coupled to a vMU 112, the downlink transport data that is communicated between the vMU 112 and the APs 114 in the base station's simulcast zone comprises time-domain user-plane data and associated control-plane data for each antenna port of the base station 124.

In one example of an implementation where the content of the downlink transport data and the manner in which each vMU 112 generates the downlink transport data from the received downlink base station data is the same for all served base stations 124 regardless of the functional split used by the served base stations 124, all downlink transport data is generated in accordance with a functional split 7-2 where the corresponding user-plane data comprises frequency-domain user-plane data. For example, where a base station 124 comprises a DU or BBU that is configured to use functional split 4 or where a base station 124 comprises a “complete” base station that is coupled to a vMU 112 using an analog RF interface, the downlink transport data that is communicated between each vMU 112 and each AP 114 in the base station's simulcast zone comprises frequency-domain user-plane data for each antenna port of the base station 124 and the vMU 112 converts the frequency-domain user-plane data to time-domain user-plane data. This can be done in order to reduce the amount of bandwidth used to transport such downlink transport data over the fronthaul network 120 (relative to communicating such user-plane data as time-domain user-plane data).

Each of the APs 114 associated with the base station 124 receives the downlink transport data, generates a respective set of downlink analog RF signals using the downlink transport data, and wirelessly transmits the respective set of analog RF signals from the respective set of coverage antennas 116 associated with that AP 114.

Where multicast addresses or VLANs are used for transmitting the downlink transport data to the APs 114 in a base station's simulcast zone, each AP 114 in the simulcast zone will receive the downlink transport data transmitted by the vMU 112 using that multicast address or VLAN.

Where downlink transport data is broadcast to all APs 114 of the vDAS 100 and the downlink transport data includes a bitmap field to indicate which APs 114 the data is intended for, all APs 114 for the vDAS 100 will receive the downlink transport data transmitted by the vMU 112 for a base station 124 but the bitmap field will be populated with data in which only the bit positions associated with the APs 114 in the base station's simulcast zone will be set to the bit value indicating that the data is intended for them and the bit positions associated with the other APs 114 will be set to the bit value indicating that the data is not intended for them. As a result, only those APs 114 in the base station's simulcast zone will fully process such downlink transport data, and the other APs 114 will discard the data after determining that it is not intended for them.

As noted above, how each AP 114 generates the set of downlink analog RF signals using the downlink transport data depends on the functional split used for communicating transport data between the vMUs 112 and the APs 114. For example, where the downlink transport data that is communicated between the vMU 112 and the APs 114 in the base station's simulcast zone comprises frequency-domain user-plane data and associated control-plane data for each antenna port of the base station 124, a RU entity implemented by each AP 114 is configured to perform the low physical layer baseband processing and RF functions for each antenna port of the base station 124 using the respective downlink transport data. This is done in order to generate a corresponding downlink RF signal for wireless transmission from a respective coverage antenna 116 associated with that AP 114. Where the downlink transport data that is communicated between the vMU 112 and the APs 114 in the base station's simulcast zone comprises time-domain user-plane data and associated control-plane data for each antenna port of the base station 124, a RU entity implemented by each AP 114 is configured to perform the RF functions for each antenna port of the base station 124 using the respective downlink transport data. This is done in order to generate a corresponding downlink RF signal for wireless transmission from a respective coverage antenna 116 associated with that AP 114.

In the uplink direction, each AP 114 included in the simulcast zone of a given base station 124 wirelessly receives a respective set of uplink RF analog signals (including the various physical channels and associated sub-carriers) received by the set of coverage antennas 116 associated with that AP 114, generates uplink transport data from the received uplink RF analog signals and communicates the uplink transport data from the AP 114 to the vMU 112 coupled to the base station 124.

As noted above, how each AP 114 generates the uplink transport data from the set of uplink analog RF signals depends on the functional split used for communicating transport data between the vMUs 112 and the APs 114. Where the uplink transport data that is communicated between each AP 114 in the base station's simulcast zone and the serving vMU 112 comprises frequency-domain user-plane data for each antenna port of the base station 124, an RU entity implemented by each AP 114 is configured to perform the RF functions and low physical layer baseband processing for each antenna port of the base station 124 using the respective uplink analog RF signal. This is done in order to generate the corresponding uplink transport data for transmission over the fronthaul network 120 to the serving vMU 112. Where the uplink transport data that is communicated between each AP 114 in the base station's simulcast zone and the serving vMU 112 comprises time-domain user-plane data for each antenna port of the base station 124, an RU entity implemented by each AP 114 is configured to perform the RF functions for each antenna port of the base station 124 using the respective uplink analog RF signal. This is done in order to generate the corresponding uplink transport data for transmission over the fronthaul network 120 to the serving vMU 112.

The vMU 112 coupled to the base station 124 receives the uplink transport data transmitted from the APs 114 in the simulcast zone of the base station 124, generates uplink base station data from the uplink transport data received from the APs 114 in the simulcast zone of the base station 124, and provides the uplink base station data to the physical donor interface 126 coupled to the base station 124. The physical donor interface 126 coupled to the base station 124 generates one or more uplink base station signals from the uplink base station data and transmits the one or more uplink base station signals to the base station 124.

In this exemplary embodiment, generating the uplink base station data for a base station 124 involves, for each uplink antenna port of the base station 124, combining or summing corresponding user-plane data included in the uplink transport data received from all the APs 114 in the base station's simulcast zone. How the corresponding user-plane data is combined or summed depends on the functional split used for communicating transport data between the vMUs 112 and the APs 114.

The form that the uplink base station signals take and how the uplink base station signals are generated from the uplink base station data also depend on how the base station 124 is coupled to the vDAS 100.

For example, where an Ethernet-based interface is used (such as O-RAN, eCPRI, or RoE) to couple the base station 124 to the vDAS 100, the vMU 112 is configured to format the uplink base station data into messages formatted in accordance with the Ethernet-based interface. The messages are provided to the associated physical Ethernet donor interface 142. The physical Ethernet donor interface 142 generates Ethernet packets for communicating the provided messages to the base station 124 via one or more Ethernet ports of that physical Ethernet donor interface 142. That is, in this example, the “uplink base station signals” comprise the physical-layer signals used to communicate such Ethernet packets.

Where a CPRI-based fronthaul interface is used for communications between the physical donor interface 126 and the base station 124, the vMU 112 is configured to format the uplink base station data into messages formatted in accordance with the CPRI fronthaul interface. The messages are provided to the associated physical CPRI donor interface 138. The physical CPRI donor interface 138 generates CPRI frames for communicating the provided CPRI messages to the base station 124 via one or more CPRI ports of that physical CPRI donor interface 138. That is, in this example, the “uplink base station signals” comprise the physical-layer signals used to communicate such CPRI frames.

Where an analog RF interface is used for communications between the physical donor interface 126 and the base station 124, the vMU 112 is configured to provide the uplink base station data (comprising the combined (that is, digitally summed) time-domain baseband IQ data for each antenna port of the base station 124) to the associated physical RF donor interface 134. The physical RF donor interface 134 uses the provided uplink base station data to generate an uplink analog RF signal for each antenna port of the base station 124 (for example, by performing a digital up conversion and digital-to-analog (DAC) process). For each antenna port of the base station 124, the physical RF donor interface 134 outputs the respective uplink analog RF signal (including the various physical channels and associated sub-carriers) to that antenna port using the appropriate RF port of the physical RF donor interface 134. That is, in this example, the “uplink base station signals” comprise the uplink analog RF signals output by the physical RF donor interface 134.

By implementing one or more nodes or functions of a traditional DAS (such as a CAN) using, or as, one or more VNFs 102 executing on one or more physical server computers 104, such nodes or functions can be implemented using COTS servers (for example, COTS servers of the type deployed in data centers or “clouds” maintained by enterprises, communication service providers, or cloud services providers) instead of custom, dedicated hardware. As a result, such nodes and functions can be deployed more cheaply and in a more scalable manner (for example, additional capacity can be added by instantiating additional VNFs 102 as needed). This is the case even if an additional physical server computer 104 is needed in order to instantiate a new vMU 112 because such physical server computers 104 are either already available in such deployments or can be easily added at a low cost (for example, because of the COTS nature of such hardware). Also, as noted above, this approach is especially well-suited for use in deployments in which base stations 124 from multiple wireless service operators share the same vDAS 100 (including, for example, neutral host deployments or deployments where one wireless service operator owns the vDAS 100 and provides other wireless service operators with access to its vDAS 100).

Other embodiments can be implemented in other ways. For example, FIGS. 3A-3D illustrates one such embodiment. FIGS. 3A-3D are block diagrams illustrating one exemplary embodiment of vDAS 300 in which at least some of the APs 314 are coupled to one or more vMU 112 serving them via one or more intermediate combining nodes (ICNs) 302. Each ICN 302 comprises at least one northbound Ethernet interface (NEI) 304 that couples the ICN 302 to Ethernet cabling used primarily for communicating with the one or more vMUs 112 and a plurality of southbound Ethernet interfaces (SEIs) 306 that couples the ICN 302 to Ethernet cabling used primarily for communicating with one or more of the plurality of APs 314.

Except as explicitly described here in connection with FIGS. 3A-3D, the vDAS 300 and the components thereof (including the vMU 112) are configured as described above.

Also, except as explicitly described here in connection with FIGS. 3A-3D, each AP 314 is implemented in the same manner as the APs 114 described above.

The ICN 302 comprises one or more programmable devices 310 that execute, or are otherwise programmed or configured by, software, firmware, or configuration logic 312 in order to implement at least some of the functions described here as being performed by an ICN 302 (including, for example, any physical layer (Layer 1) baseband processing described here as being performed that ICN 302). The one or more programmable devices 310 can be implemented in various ways (for example, using programmable processors (such as microprocessors, co-processors, and processor cores integrated into other programmable devices) and/or programmable logic (such as FPGAs and system-on-chip packages)). Where multiple programmable devices are used, all of the programmable devices do not need to be implemented in the same way.

The ICN 302 can be implemented as a physical network function using dedicated, special-purpose hardware. Alternatively, the ICN 302 can be implemented as a virtual network function running on a physical server. For example, the ICN 302 can be implemented in the same manner as the vMU 112 described above in connection with FIGS. 1A-1C.

As noted above, the fronthaul network 320 used for transport between each vMU 112 and the APs 114 and ICNs 302 (and the APs 314 coupled thereto) can be implemented in various ways. Various examples of how the fronthaul network 320 can be implemented are illustrated in FIGS. 3A-3D. In the example shown in FIG. 3A, the fronthaul network 320 is implemented using a switched Ethernet network 322 that is used to communicatively couple each AP 114 and each ICN 302 (and the APs 314 coupled thereto) to each vMU 112 serving that AP 114 or 314 or ICN 302.

In the example shown in FIG. 3B, the fronthaul network 320 is implemented using only point-to-point Ethernet links 324, where each AP 114 and each ICN 302 (and the APs 314 coupled thereto) is coupled to each serving vMU 112 serving it via a respective one or more point-to-point Ethernet links 324. In the example shown in FIG. 3C, the fronthaul network 320 is implemented using a combination of a switched Ethernet network 322 and point-to-point Ethernet links 324. In the example shown in FIG. 3D, a first ICN 302 has a second ICN 302 subtended from it so that some APs 314 are communicatively coupled to the first ICN 302 via the second ICN 302. Again, as noted above, it is to be understood that FIGS. 1A-2C and 3A-2D illustrate only a few examples of how the fronthaul network (and the vDAS more generally) can be implemented and that other variations are possible.

In this exemplary embodiment, each vMU 112 that serves the ICN 302 treats the ICN 302 as one or more “virtual APs” to which it sends downlink transport data for one or more base stations 124, and from which it receives uplink transport data, for the one or more base stations 124. The ICN 302 forwards the downlink transport data to, and combines uplink transport data received from, one or more of the APs 314 coupled to the ICN 302.

In one implementation of such an embodiment, the ICN 302 forwards the downlink transport data it receives for all the served base stations 124 to all of the APs 314 coupled to the ICN 302 and combines uplink transport data it receives from all of the APs 314 coupled to the ICN 302 for all of the base stations 124 served by the ICN 302.

In another implementation, the ICN 302 is configured so that a separate subset of the APs 314 coupled to that ICN 302 can be specified for each base station 124 served by that ICN 302. In such an implementation, for each base station 124 served by an ICN 302, the ICN 302 forwards the downlink transport data it receives for that base station 124 to the respective subset of the APs 314 specified for that base station 124 and combines the uplink transport data it receives from the subset of the APs 314 specified for that base station 124. That is, in this implementation, each ICN 302 can be used to forward the downlink transport data for different served base stations 124 to different subsets of APs 314 and to combine uplink transport data the ICN 302 receives from different subsets of APs 314 for different served base stations 124. Various techniques can be used to do this. For example, the ICN 302 can be configured to inspect one or more fields (or other parts) of the received transport data to identify which base station 124 the transport data is associated with. In another implementation, the ICN 302 is configured to appear as different virtual APs for different served base stations 124 and is configured to inspect one or more fields (or other parts) of the received transport data to identify which virtual AP the transport data is intended for.

In the exemplary embodiments shown in FIGS. 3A-3D, each ICN 302 is configured to use a time synchronization protocol (for example, the Institute of Electrical and Electronics Engineers (IEEE) 1588 Precision Time Protocol (PTP) or the Synchronous Ethernet (SyncE) protocol) to synchronize itself to a timing master entity established for the vDAS 300 by communicating over the switched Ethernet network 122. Each AP 314 coupled to an ICN 302 is configured to synchronize itself to the time base used in the rest of the vDAS 300 based on the synchronous Ethernet communications provided from the ICN 302.

In one example of the operation of the vDAS 300 of FIGS. 3A-3D, in the downlink direction, each ICN 302 receives downlink transport data for the base stations 124 served by that ICN 302 and communicates, using the southbound Ethernet interfaces 306 of the ICN 302, the downlink transport data to one or more of the APs 314 coupled to ICN 302. As noted above, each vMU 112 that is coupled to a base station 124 served by a ICN 302 treats the ICN 302 as a virtual AP and addresses downlink transport data for that base station 124 to the ICN 302, which receives it using the northbound Ethernet interface 304.

As noted above, for each served base station 124, the ICN 302 forwards the downlink transport data it receives from the serving vMU 112 for that base station 124 to one or more of the APs 314 coupled to the ICN 302. For example, as noted above, the ICN 302 can be configured to simply forward the downlink transport data it receives for all served base stations 124 to all of the APs 314 coupled to the ICN 302 or the ICN 302 can be configured so that a separate subset of the APs 314 coupled to the ICN 302 can be specified for each served base station 124, where the ICN 302 is configured to forward the downlink transport data it receives for each served base station 124 to only the specific subset of APs 314 specified for that base station 124.

Each AP 314 coupled to the ICN 302 receives the downlink transport data transmitted to it, generates respective sets of downlink analog RF signals for all base stations 124 served by the ICN 302, and wirelessly transmits the downlink analog RF signals for all of the served base stations 124 from the set of coverage antennas 116 associated with the AP 314.

Each such AP 314 generates the respective set of downlink analog RF signals for all of the base stations 124 served by the ICN 302 as described above. That is, how each AP 314 generates the set of downlink analog RF signals using the downlink transport data depends on the functional split used for communicating transport data between the vMUs 112, ICNs 302, and the APs 114 and 314. For example, where the downlink transport data comprises frequency-domain user-plane data and associated control-plane data for each antenna port of the base station 124, a RU entity implemented by each AP 314 is configured to perform the low physical layer baseband processing and RF functions for each antenna port of the base station 124 using the respective downlink transport data. This is done in order to generate a corresponding downlink RF signal for wireless transmission from a respective coverage antenna 316 associated with that AP 314. Where the downlink transport data comprises time-domain user-plane data and associated control-plane data for each antenna port of the base station 124, a RU entity implemented by each AP 314 is configured to perform the RF functions for each antenna port of the base station 124 using the respective downlink transport data. This is done in order to generate a corresponding downlink RF signal for wireless transmission from a respective coverage antenna 316 associated with that AP 314.

In the uplink direction, each AP 314 coupled to the ICN 302 that is used to serve a base station 124 receives a respective set of uplink RF analog signals (including the various physical channels and associated sub-carriers) for that served base station 124. The uplink RF analog signals are received by the AP 314 via the set of coverage antennas 116 associated with that AP 314. Each such AP 314 generates respective uplink transport data from the received uplink RF analog signals for the served base station 124 and communicates, using the respective Ethernet interface 210 of the AP 314, the uplink transport data to the ICN 302.

Each such AP 314 generates the respective uplink transport data from the received uplink analog RF signals for each served base station 124 served by the AP 314 as described above. That is, how each AP 314 generates the uplink transport data from the set of uplink analog RF signals depends on the functional split used for communicating transport data between the vMUs 112, ICNs 302, and the APs 114 and 314. Where the uplink transport data comprises frequency-domain user-plane data, an RU entity implemented by each AP 314 is configured to perform the RF functions and low physical layer baseband processing for each antenna port of the base station 124 using the respective uplink analog RF signal. This is done in order to generate the corresponding uplink transport data for transmission to the ICN 302. Where the uplink transport data comprises time-domain user-plane data, an RU entity implemented by each AP 314 is configured to perform the RF functions for each antenna port of the base station 124 using the respective uplink analog RF signal. This is done in order to generate the corresponding uplink transport data for transmission to the ICN 302.

The ICN 302 receives respective uplink transport data transmitted from the APs 314 coupled to the ICN 302 or any ICN 302 subtended from it. The respective uplink transport data transmitted from any subtended APs 314 and/or subtended ICNs 302 is received by the ICN 302 using the respective southbound Ethernet interfaces 306.

The ICN 302 extracts the respective uplink transport data for each served base station 124 and, for each served base station 124, combines or sums corresponding user-plane data included in the extracted uplink transport data received from the one or more subtended APs 314 and/or ICNs 302 coupled to that ICN 302 used to serve that base station 124. The manner in which each ICN 302 combines or sums the user-plane data depends on whether the user-plane data comprises time-domain data or frequency-domain data. Generally, the ICN 302 combines or sums the user-plane data in the same way that each vMU 112 does so.

The ICN 302 generates uplink transport data for each served base station 124 that includes the respective combined user-plane data for that base station 124 and communicates the combined uplink transport data for each served base station 124 to the vMU 112 associated with that base station 124 or an upstream ICN 302. In this exemplary embodiment described here in connection with FIGS. 3A-3D, an O-RAN fronthaul interface is used for communicating over the fronthaul network 120, and each ICN 302 is configured to generate and format the uplink transport data in accordance with that O-RAN fronthaul interface.

The ICN 302 shown in FIGS. 3A-3D can be used to increase the number of APs 314 that can be served by each vMU 112 while reducing the processing and bandwidth load relative to directly connecting the additional APs 314 to each such vMU 112.

FIG. 4 is a block diagram illustrating one exemplary embodiment of vDAS 400 in which one or more physical donor RF interfaces 434 are configured to bypass the vMU 112.

Except as explicitly described here in connection with FIG. 4, the vDAS 400 and the components thereof are configured as described above.

In the exemplary embodiment shown in FIG. 4, the vDAS 400 includes at least one physical RF donor interface 434 that is configured to bypass the vMU 112 and instead, for the base stations 124 coupled to that physical RF donor interface 434, have that physical RF donor interface 434 perform those functions described above as being performed by the vMU 112. These functions include, for the downlink direction, receiving a set of downlink RF analog signals from each base station 124 coupled to the physical RF donor interface 434, generating downlink transport data from the set of downlink RF analog signals and communicating the downlink transport data to one or more of the APs 114 or ICNs 302 and, in the uplink direction, receiving respective uplink transport data from one or more APs 114 or ICNs 302, generating a set of uplink RF analog signals from the received uplink transport data (including performing any digital combining or summing of user-plane data), and providing the uplink RF analog signals to the appropriate base stations 124. In this exemplary embodiment, each physical RF donor interface 434 includes one or more physical Ethernet transport interfaces 448 for communicating the transport data to and from the APs 114 and ICNs 302 subtended from the physical RF donor interface 434. The vDAS 400 (and the physical RF donor interface 434) can be used with any of the configurations described above (including, for example, those shown in FIGS. 1A-1C and FIGS. 3A-3D).

The physical RF donor interface 434 can be used to reduce the overall latency associated with serving the base stations 124 coupled to that physical RF donor interface 434.

As noted above, various entities in the vDAS 100, 300, or 400 combine or sum uplink data. For example, in the exemplary embodiment described above in connection with FIGS. 1A-1C, as a part of generating the uplink base station data for each uplink antenna port of a base station 124, the corresponding vMU 112 combines or sums corresponding user-plane data included in the uplink transport data received from APs 114 in the base station's simulcast zone. In the exemplary embodiment described above in connection with FIGS. 3A-3D, each ICN 302 also performs uplink combining or summing in the same general manner that the vMU 112 does. Also, in the exemplary embodiment described above in connection with FIG. 4, each physical donor RF interface 434 that is configured to bypass the vMU 112 also performs uplink combining or summing in the same general manner that the vMU 112 does.

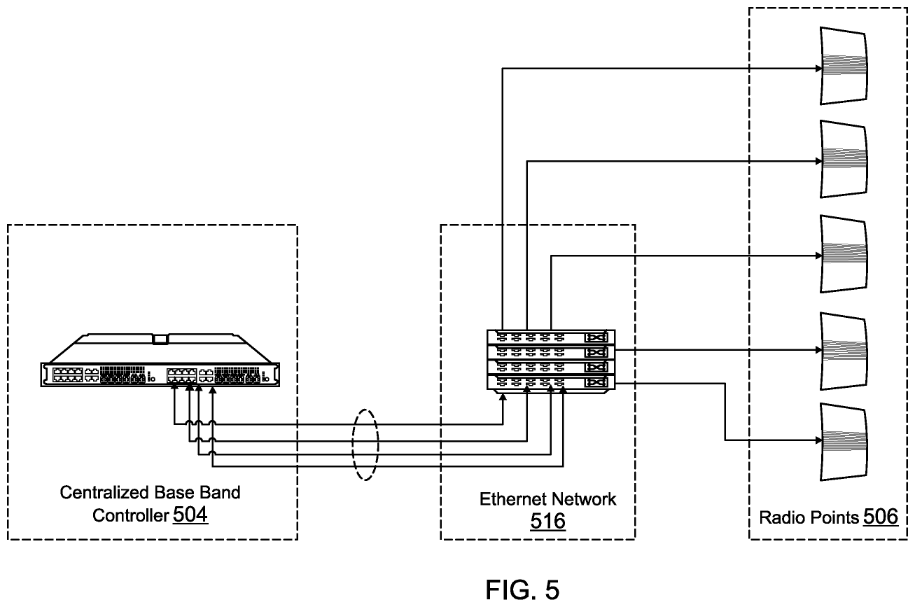

FIG. 5 is a block diagram illustrating one exemplary embodiment of a radio access network (RAN) system 500. The system 500 may be deployed at a site to provide wireless coverage and capacity for one or more wireless network operators. The site may be, for example, a building or campus or other grouping of buildings (used, for example, by one or more businesses, governments, or other enterprise entities) or some other public venue (such as a hotel, resort, amusement park, hospital, shopping center, airport, university campus, arena, or an outdoor area such as a ski area, stadium or a densely-populated downtown area).

In the exemplary embodiment shown in FIG. 5, the system 500 is implemented at least in part using a C-RAN (point-to-multipoint distributed base station) architecture that employs at least one centralized baseband controller (BC) 504 and multiple radio points (RPs) 506 to serve UE 116 within at least one cell. The system 500 may also be referred to as a “C-RAN system” 100. The BC 504 may also be referred to as “baseband unit” 504 or just “controller” 504. Each RP 506 may include or be coupled to one or more antennas via which downlink RF signals are radiated to UE 116 and via which uplink RF signals transmitted by UEs 116 are received.

The system 500 may be coupled to a core network for each of one or more wireless network operators over an appropriate back-haul. For example, the system 500 may be coupled to the core network through the Internet, serving as a back-haul between the system 500 and any core network. However, it is to be understood that the back-haul can be implemented in other ways. Further, the system 500 may be implemented as a 4G or 5G radio access network that extends wireless service provided from the core network. Thus, the system 500 extends mobile access to the core network of the wireless network operator to facilitate the wireless transmission of data and voice by UE.

In the exemplary embodiment shown in FIG. 5, the front-haul that communicatively couples the BC 504 to the one or more RPs 506 may be implemented using a standard ETHERNET network 516. However, it is to be understood that the front-haul between the BC 104 and RPs 106 can be implemented in other ways.

In some embodiments, one or more nodes in a C-RAN perform analog radio frequency (RF) functions for the air interface as well as digital Layer 1, Layer 2, and Layer 3 (of the Open Systems Interconnection (OSI) model) functions for the air interface. Further, the system 500 may follow the ORAN 7.x split or other similar functional divide between the operation of the BC 504 and the RPs 506. In the ORAN option 7.x split, wherein the functionality of the physical layer is divided between the BC 504 and the RPs 506. For example, the BC 504 may perform higher PHY layer functions while the RPs 506 perform lower PHY layer functionalities. In some implementations, the system 500 may be a hybrid functional split. For example, the RPs 506 may process the SRS, PRACH, and PUCCH channels to reduce the load on the BC 504.

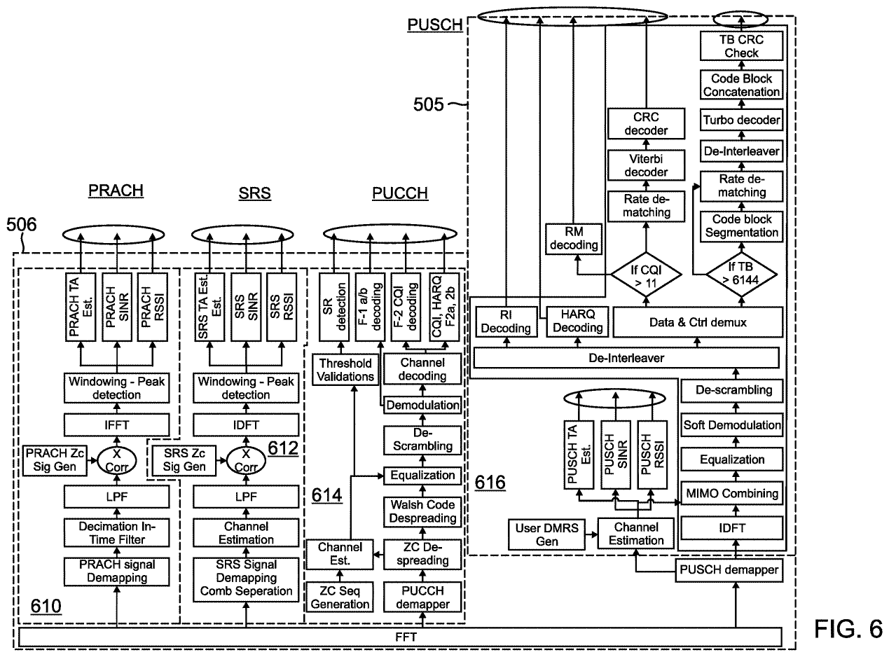

FIG. 6 is a block diagram illustrating an exemplary hybrid functional split between the BC 504 and the RPs 506 in the uplink direction. As mentioned above and illustrated in FIG. 6, the RPs 506 may process the PRACH 610, SRS channel 612, and PUCCH 614. Additionally, the BC 504 may process the PUSCH 616. Splitting the functions between the RP 506 and the BC 504 can be used to balance the computational load on the BC 504 and any connected RPs 506. If the BC 504 is connected to a high number of RPs 506, increasing the functions performed by the separate RPs 506 can reduce the computational load that could arise from processing functions associated with the separate RPs 506.

In certain embodiments, an RP 506 may receive a signal from user equipment and perform an FFT on the received signal to transform the received signals from the time domain into the frequency domain. The RP 506 may process portions of the received signal and/or provide portions of the transformed signal to the BC 504 for additional processing. For example, portions of the signal associated with the PRACH 610, the SRS channel 612, or the PUCCH 614 may be processed by the RP 506. Other portions of the signal, like those associated with the PUSCH 616, may be provided to the BC 504 for additional processing.

When a message from the UE is processed within the PRACH 610, the RP 506 may demap the PRACH signal to extract a RACH preamble from the subcarriers assigned to the PRACH. The RP 506 may then perform a decimation in time to reduce the number of samples in the signal. Further, the RP 506 may pass the decimated signal through a low-pass filter to remove high-frequency components caused by the decimation. Moreover, the RP 506 may generate a PRACH Zadoff-Chu (ZC) sequence for cross-correlation with the sampled signal. Based on the cross-correlation, the RP 506 can detect the presence and timing of the RACH preamble. After the RP 506 performs the cross-correlation, the RP 506 then performs an IFFT and performs windowing and peak detection. From the windowing and peak detection, the RP 506 calculates the TA estimate, SINR, and RSSI for the PRACH 610.

When a message from the UE or UEs is processed within the SRS channel 612, the RP 506 may demap the SRS signal and perform comb separation. The RP 506 may then perform a channel estimation and low-pass filtering. Moreover, the RP 506 may generate a Zadoff-Chu (ZC) sequence for cross-correlation with the sampled signal. After the RP 506 performs the cross-correlation, the RP 506 performs an IDFT on the signal and performs windowing and peak detection. From the windowing and peak detection, the RP 506 calculates the TA estimate, SINR, and RSSI for the SRS channel 612.

When a message from the UE is processed within the PUCCH 614, the RP 506 may demap the PUCCH signal and perform ZC dispreading. With the ZC despreading, the RP 506 may perform channel estimation using a ZC sequence generation. Also, the RP 506 may perform Walsh code despreading. Further, after channel estimation and Walsh code dispreading, the PUCCH may perform equalization and threshold validations. After performing the threshold validations, the PUCCH may perform SR detection. Additionally, after performing equalization, the RP 506 may perform descrambling and demodulation.

After performing the demodulation, the PUCCH may perform F-1 a/b decoding and channel decoding. After channel decoding, the PUCCH may perform F-2 CQI decoding and calculate the CQI, HARQ, F 2a, and 2b.

In certain embodiments, when a message is processed within the PUSCH 616, the RP may perform PUSCH demapping before passing the signal to the BC 504 for additional processing. The BC 504 may receive the signal from the RP 506 and perform channel estimation using a user DMRS generation to calculate the PUSCH TA estimation, SINR, and RSSI. Additionally, the BC 504 performs an IDFT and then MIMO combining using the channel estimation and result from the IDFT. After performing the MIMO combining, the BC 504 performs equalization, soft demodulation, and descrambling. After performing the descrambling, the BC 504 performs deinterleaving. With the deinterleaving completed, the BC 504 performs RI decoding and HARQ decoding. Additionally, the BC 504 performs data and control demultiplexing. With the results of the data and control demultiplexing, the BC 504 determines whether the channel quality indicator (CQI) is greater than 11. If the CQI is less than a particular number (for example, 11), the BC 504 may perform RM decoding. If the CQI exceeds the particular number, the BC 504 may perform rate dematching, Viterbi decoding, and CRC decoding. Additionally, the BC 504 may use the result from the data and control demultiplexing to determine if the transport block (TB) is greater than a particular size. If the TB exceeds the particular size, the BC 504 may perform code block segmentation. However, if the TB is less than the particular size, the BC 504 may skip the code block segmentation and perform rate dematching. After performing the rate dematching, the BC 504 performs deinterleaving, turbo decoding, code block concatenation, and a TB CRC check.

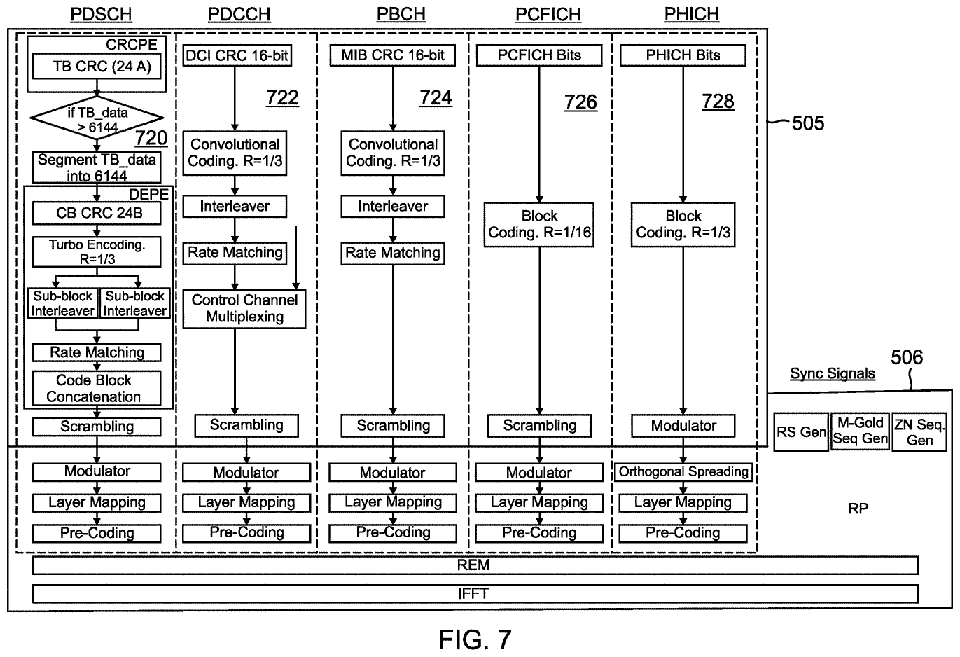

FIG. 7 is a block diagram illustrating a hybrid functional split between the BC 504 and the RPs 506 in the downlink direction. As shown, portions of the processing associated with the physical downlink shared channel (PDSCH) 720, physical downlink control channel (PDCCH) 722, physical broadcast channel (PBCH) 724, physical control format indicator channel (PCFICH) 726, and physical HARQ indicator channel (PHICH) 728 are performed within the BC 504 and other portions are performed by associated RPs 506.

Within the PDSCH 720, the BC 504 may calculate a CRC for the transfer block as part of the cyclic redundancy check and polar encoding (CRCPE). The BC 504 may then check if the size of the TB is greater than a certain size. If the size of the TB is greater than 6144, the BC 504 segments the TB into smaller code blocks. After segmentation, the BC 504 then calculates CRCs for the code blocks and performs turbo encoding and interleaving on the code blocks. Further, the BC 504 performs rate matching, code block concatenation, and scrambling to prepare the signals for transmission. The BC 504 then transmits the signal to the RP 506.

For the PDSCH 720, the RP 506 may receive the signal from the BC 504 and modulate the signal. After modulation, the RP 506 may perform layer mapping, mapping the signals to different MIMO layers. After layer mapping, the RP 506 may perform precoding in preparation for transmission of the signals. When the precoding is complete, the RP 506 performs resource mapping and an IFFT on the signal before transmission to connected UEs.

For the PDCCH 722, the BC 504 may calculate a CRC for downlink control information. After calculating the CRC, the BC 504 may perform convolutional coding, interleaving, and rate matching. When the rate matching is completed, the BC 504 may perform control channel multiplexing and scrambling before providing the signal to the RP 506. Within the RP 506, the RP 506 modulates the received signal. After modulation, the RP 506 may perform layer mapping and precoding. When the precoding is complete, the RP 506 performs resource mapping and an IFFT on the signal before transmission to connected UEs.

For the PBCH 724, the BC 504 may calculate a CRC for the master information block. After calculating the CRC, the BC 504 may perform convolutional coding interleaving, rate matching, and scrambling before providing the signal to the RP 506. Within the RP 506, the RP 506 modulates the received signal. After modulation, the RP 506 may perform layer mapping and precoding. When the precoding is complete, the RP 506 performs resource mapping and an IFFT on the signal before transmission to connected UEs.

For the PCFICH, the BC 504 may set control format indicator (CFI) bits and perform block coding and scrambling before providing the signal to the RP 506. Within the RP 506, the RP 506 modulates the received signal. After modulation, the RP 506 may perform layer mapping and precoding. When the precoding is complete, the RP 506 performs resource mapping and an IFFT on the signal before transmission to connected UEs.

For the PHICH, the BC 504 may set PHICH bits and perform block coding and modulation before providing the signal to the RP 506. Within the RP 506, the RP 506 may perform orthogonal spreading on the received signal. After performing the spreading, the RP 506 may perform layer mapping and precoding. When the precoding is complete, the RP 506 performs resource mapping and an IFFT on the signal before transmission to connected UEs.

In addition to processing the signals from the BC 504, the RP 506 may generate synchronization signals for transmission to the UE. In particular, the RP 506 may generate a reference signal, an M-Gold sequence, and a Zadoff-Chu sequence. These signals may aid in synchronizing the operation of the RU with connected UEs.

Returning to FIG. 5, in some implementations, the system 500 may be deployed alongside a DAS, such as the DAS described above in FIGS. 1A-4 or other types of DASs with varying topologies. When deployed alongside each other, various challenges and processing limitations may arise.

In some embodiments, the components of the system 500 may process some of the control channels for each RU to perform UE localization. In contrast, a DAS typically sums the uplink into a single stream of uplink data, which results in a loss of localization data with regard to the access points of the DAS. Without the UE localization data, deploying the system 500 with a DAS may be unable to reuse network resources to increase capacity and efficiency. Additionally, the system 500 and similar systems may employ interference rejection combining (IRC) across multiple RPs for a given UE. The implementation of IRC may call for localization and thus may not be possible when the system 500 is combined with a DAS, such as a vDAS 100. Further, when a DAS is connected through an RF source, the number of RPs required for reuse and RP combining increases the input donor configuration of the DAS, which may be expensive.

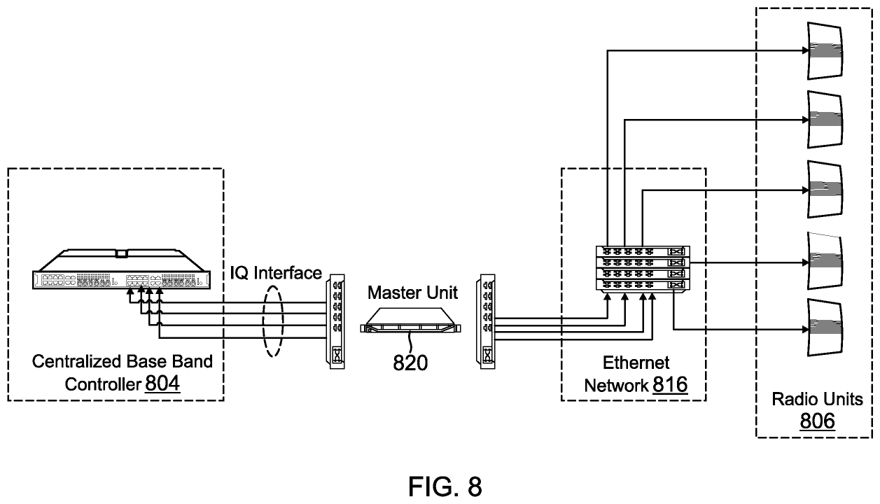

FIG. 8 is a block diagram of a system 800, where a master unit of a DAS is incorporated to act as a virtual radio point within the system that is similar to the system 500. For example, the system 800 includes a BC 805, an ethernet network 816, and distributed radio units 806, which function similarly to the BC 505, the ethernet network 516, and RPs 506 in FIG. 5. However, the system 800 further includes a master unit 820 coupled to the BC 504, wherein the master unit 820 is configured to function as a virtual radio unit from the perspective of the BC 804. Thus, the BC 804 may function as a driver for the DAS associated with the master unit 820, though the master unit 820 appears as one or more virtual radio units.

In certain embodiments, when connecting to the radio units 806, the master unit 820 may connect through a fronthaul network, such as the ethernet network 816, to one or more RUs 806. In some implementations, the master unit 820 may be connected to the RUs 806 in one of several topologies. For example, as illustrated, a single master unit 820 may connect to multiple RUs 806 in 1:N topology. Alternatively, the BC 804 may drive multiple master units 820 coupled to a shared set of RUs 806 in an N:1 topology. Additionally, a master unit 820 may connect to a single RU 806 in a 1:1 topology. Further, a master unit 820 may act as multiple virtual RUs from the perspective of the BC 804.

In some embodiments, the number of master units 820 deployed as virtual RUs may depend on the number of reuse layers, the independent processing of the PUCCH by the RUs, the reception of the PUSCH by the RUs per UE in combining zones, the SRS channel, and the PRACH.

In additional embodiments, the master unit 820 may be scaled horizontally by connecting multiple master units 820 to the BC 804. Additionally, the master unit 820 may be vertically scaled by increasing the capabilities of the master unit 820. In particular, the master unit 820 may be scaled horizontally or vertically based on the deployed configuration. In some implementations, the master unit 820 may be deployed on COTS hardware, where the core and memory requirements of the selected hardware are based on the number of virtual RUs deployed within the master unit 820.

In further embodiments, the master unit can interface with several different communication standards. For example, the master unit 820 may interface with an ORAN donor and provide information through an ORAN interface. Alternatively, the master unit 820 may interface with a CPRI donor and provide information through an ORAN or CPRI interface. In particular, the master unit 820 may perform interface translation to appear like a master unit to devices on the southbound interface and like a RU for interfacing with an interface on the BC 804 on the northbound interface.

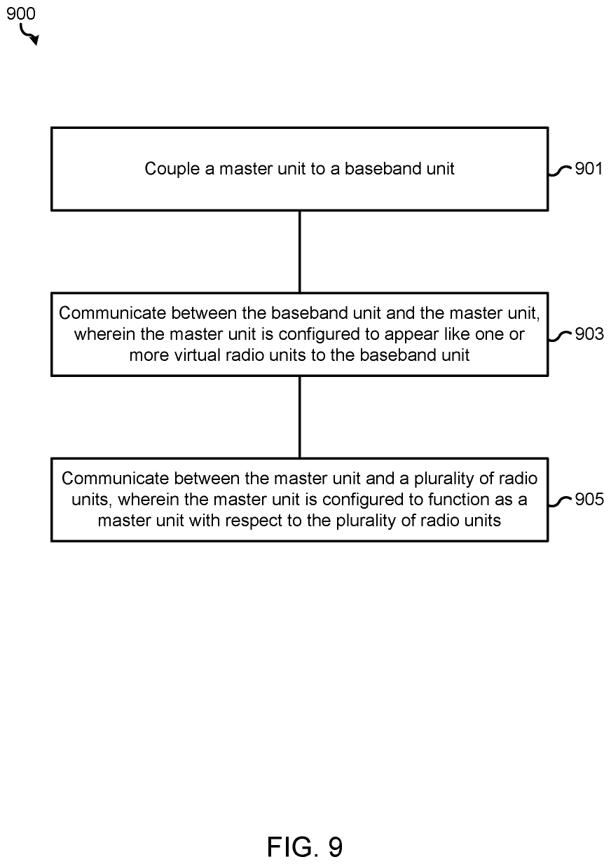

FIG. 9 is flowchart diagram of a method 900 for implementing virtual radio units to support cloud RAN and DAS. The method 900 proceeds at 901, where a master unit is coupled to a baseband unity. Further, the method 900 proceeds at 903, where the baseband unit and the master unit are communicating, wherein the master unit is configured to appear like one or more virtual radio units to the baseband unit. Additionally, the method 900 proceeds at 901, where the master unit and a plurality of radio units are communicating, wherein the master unit is configured to function as a master unit with respect to the plurality of radio units.

### EXAMPLE EMBODIMENTS

Example 1 includes a system comprising: a baseband unit coupled to one or more base stations; a master unit coupled to the one or more baseband units; and a plurality of radio units coupled to the master unit; wherein the master unit is configured to function as one or more virtual radio units.
Example 2 includes the system of Example 1, wherein the master unit provides an interface for a distributed antenna system from at least one of: an ORAN donor; and a CPRI donor.
Example 3 includes the system of any of Examples 1-2, wherein the master unit provides interface translation between the baseband unit and the plurality of radio units.
Example 4 includes the system of Example 3, wherein the interface translation acts as a master unit interface in a southbound interface and baseband unit interface in a northbound interface.
Example 5 includes the system of any of Examples 1-4, wherein the master unit processes one or more channels, wherein the one or more channels comprise at least one of: a PRACH; a SRS channel; and a PUCCH.
Example 6 includes the system of any of Examples 1-5, wherein a virtual radio unit in the one or more virtual radio units is associated with a set of radio units in the plurality of radio units.
Example 7 includes the system of any of Examples 1-6, wherein the one or more virtual radio units comprises multiple virtual radio units and each virtual radio unit in the multiple virtual radio units is associated with a unique set of radio units in the plurality of radio units.
Example 8 includes the system of any of Examples 1-7, wherein the master unit implements control-plane, user-plane, synchronization-plane, and management-plane functionality associated with a single RU.
Example 9 includes the system of any of Examples 1-8, wherein the master unit is coupled to the plurality of radio units in at least one of: a 1:1 topology; a 1:N topology; and an N:1 topology.
Example 10 includes the system of any of Examples 1-9, wherein the master unit is deployed using commercial-off-the-shelf hardware.
Example 11 includes a method comprising: coupling a master unit to a baseband unit; communicating between the baseband unit and the master unit, wherein the master unit is configured to appear like one or more virtual radio units to the baseband unit; and communicating between the master unit and a plurality of radio units, wherein the master unit is configured to function as a master unit with respect to the plurality of radio units.
Example 12 includes the method of Example 11, wherein the master unit provides an interface for a DAS from at least one of: an ORAN donor; and a CPRI donor.
Example 13 includes the method of any of Examples 11-12, wherein the master unit provides interface translation between the baseband unit and the plurality of radio units.
Example 14 includes the method of Example 13, wherein the interface translation acts as an MU interface and baseband unit interface.
Example 15 includes the method of any of Examples 11-14, wherein a virtual radio unit in the one or more virtual radio units is associated with a set of radio units in the plurality of radio units.
Example 16 includes the method of any of Examples 11-15, wherein the one or more virtual radio units comprises multiple virtual radio units, and each virtual radio unit in the multiple virtual radio units is associated with a unique set of radio units in the plurality of radio units.
Example 17 includes the method of any of Examples 11-16, wherein the master unit implements control-plane, user-plane, and synchronization plane, and management-plane functionality associated with a single RU.
Example 18 includes the method of any of Examples 11-17, wherein the master unit is deployed using commercial-off-the-shelf hardware.
Example 19 includes a system comprising: a baseband unit coupled to one or more base stations; a master unit coupled to the one or more baseband units; and a plurality of radio units coupled to the master unit; wherein the master unit is configured to function as one or more virtual radio units and a virtual radio unit is associated with a set of radio units in the plurality of radio units; wherein the master unit provides interface translation between the baseband unit and the plurality of radio units.
Example 20 includes the system of Example 19, wherein the one or more virtual radio units comprises multiple virtual radio units, and each virtual radio unit in the multiple virtual radio units is associated with a unique set of radio units in the plurality of radio units.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed:

1. A system comprising:
a baseband unit coupled to one or more base stations;
a master unit coupled to the one or more baseband units; and
a plurality of radio units coupled to the master unit;
wherein the master unit is configured to function as one or more virtual radio units.

2. The system of claim 1, wherein the master unit provides an interface for a distributed antenna system from at least one of:
an ORAN donor; and
a CPRI donor.

3. The system of claim 1, wherein the master unit provides interface translation between the baseband unit and the plurality of radio units.

4. The system of claim 3, wherein the interface translation acts as a master unit interface in a southbound interface and baseband unit interface in a northbound interface.

5. The system of claim 1, wherein the master unit processes one or more channels, wherein the one or more channels comprise at least one of:
a PRACH;
a SRS channel; and
a PUCCH.

6. The system of claim 1, wherein a virtual radio unit in the one or more virtual radio units is associated with a set of radio units in the plurality of radio units.

7. The system of claim 1, wherein the one or more virtual radio units comprises multiple virtual radio units and each virtual radio unit in the multiple virtual radio units is associated with a unique set of radio units in the plurality of radio units.

8. The system of claim 1, wherein the master unit implements control-plane, user-plane, synchronization-plane, and management-plane functionality associated with a single RU.

9. The system of claim 1, wherein the master unit is coupled to the plurality of radio units in at least one of:
a 1:1 topology;
a 1:N topology; and
an N:1 topology.

10. The system of claim 1, wherein the master unit is deployed using commercial-off-the-shelf hardware.

11. A method comprising:
coupling a master unit to a baseband unit;
communicating between the baseband unit and the master unit, wherein the master unit is configured to appear like one or more virtual radio units to the baseband unit; and
communicating between the master unit and a plurality of radio units, wherein the master unit is configured to function as a master unit with respect to the plurality of radio units.

12. The method of claim 11, wherein the master unit provides an interface for a DAS from at least one of:
an ORAN donor; and
a CPRI donor

13. The method of claim 11, wherein the master unit provides interface translation between the baseband unit and the plurality of radio units.

14. The method of claim 13, wherein the interface translation acts as an MU interface and baseband unit interface.

15. The method of claim 11, wherein a virtual radio unit in the one or more virtual radio units is associated with a set of radio units in the plurality of radio units.

16. The method of claim 11, wherein the one or more virtual radio units comprises multiple virtual radio units, and each virtual radio unit in the multiple virtual radio units is associated with a unique set of radio units in the plurality of radio units.

17. The method of claim 11, wherein the master unit implements control-plane, user-plane, and synchronization plane, and management-plane functionality associated with a single RU.

18. The method of claim 11, wherein the master unit is deployed using commercial-off-the-shelf hardware.

19. A system comprising:
a baseband unit coupled to one or more base stations;
a master unit coupled to the one or more baseband units; and
a plurality of radio units coupled to the master unit;
wherein the master unit is configured to function as one or more virtual radio units and a virtual radio unit is associated with a set of radio units in the plurality of radio units;
wherein the master unit provides interface translation between the baseband unit and the plurality of radio units.

20. The system of claim 19, wherein the one or more virtual radio units comprises multiple virtual radio units, and each virtual radio unit in the multiple virtual radio units is associated with a unique set of radio units in the plurality of radio units.
